(19) United States
(12) Patent Application Publication
(10) Pub. No.: US 2025/0280364 A1
(43) Pub. Date: Sep. 4, 2025

(54) Device Control System and Method, Device, Readable Storage Medium, and Chip

(71) Applicant: Huawei Technologies Co., Ltd., Shenzhen (CN)

(72) Inventors: Qinyong Jia, Shanghai (CN); Liang Wang, Shanghai (CN)

(21) Appl. No.: 19/191,500

(22) Filed: Apr. 28, 2025

Related U.S. Application Data
(63) Continuation of application No. PCT/CN2023/120755, filed on Sep. 22, 2023.

(30) Foreign Application Priority Data
Oct. 28, 2022 (CN) 202211338700.2

(51) Int. Cl. H04W 52/02; H04W 56/00

(52) U.S. Cl. CPC H04W 52/0248; H04W 56/001

(57) ABSTRACT

A gateway device connected to a plurality of electronic devices determines a target scanning period of the electronic devices, where the target scanning period includes a wake-up time and a sleep time. The gateway device synchronizes signal scanning processes of the electronic devices based on the target scanning period, and sends a control instruction to the electronic devices when the electronic devices are all within the wake-up time in the target scanning period. Each electronic device can receive and execute the control instruction. The electronic devices perform signal scanning synchronously and can simultaneously receive and execute the control instruction of the gateway device.

### CROSS-REFERENCE TO RELATED APPLICATIONS

This is a continuation of Int'l Patent App. No. PCT/CN2023/120755 filed on Sep. 22, 2023, which claims priority to Chinese Patent App. No. 202211338700.2 filed on Oct. 28, 2022, both of which are incorporated by reference.

### TECHNICAL FIELD

This disclosure relates to the field of device control technologies, and in particular, to a device control system and method, a device, a readable storage medium, and a chip.

### BACKGROUND

In the whole-house smart home field, a gateway device may be connected to a plurality of single-live-wire smart home devices and control the plurality of single-live-wire smart home devices, which are briefly referred to as single-live-wire devices. A circuit of the single-live-wire device is in a power-on state regardless of whether the single-live-wire device is working or stops working, and a difference is that a current is larger when the single-live-wire device is working and is smaller when the single-live-wire device stops working.

To reduce power consumption when the single-live-wire device stops working, the single-live-wire device usually receives a control instruction of the gateway device in an intermittent wake-up and sleep manner. For example, each time after the single-live-wire device wakes up for 60 milliseconds (ms) and receives a control instruction, the single-live-wire device sleeps for 120 ms. When the gateway device controls a plurality of single-live-wire devices simultaneously, some of the plurality of single-live-wire devices may be in a wake-up state, and some may be in a sleep state. Generally, the plurality of single-live-wire devices cannot simultaneously receive a control instruction of the gateway device and perform corresponding control operations, resulting in poor user experience. For example, when the gateway device controls a plurality of single-live-wire lights to be turned on, the plurality of single-live-wire lights usually cannot receive a control instruction from the gateway device simultaneously, and cannot be turned on simultaneously, resulting in poor user experience.

### SUMMARY

This disclosure provides a device control system and method, a device, a readable storage medium, and a chip, to resolve a problem that user experience is poor because a plurality of electronic devices under control in a control network cannot simultaneously respond to a control instruction of a gateway device.

According to a first aspect, an embodiment of this disclosure provides a device control system, including a gateway device and a plurality of electronic devices connected to the gateway device. The gateway device is configured to: determine a target scanning period of the plurality of electronic devices, where the target scanning period includes a wake-up time and a sleep time; synchronize signal scanning processes of the plurality of electronic devices based on the target scanning period; and send a control instruction to the plurality of electronic devices when the plurality of electronic devices is all within the wake-up time in the target scanning period. The electronic device is configured to: receive and execute the control instruction.

It should be noted that the electronic device performs signal scanning when the electronic device is within the wake-up time, and does not perform signal scanning when the electronic device is within the sleep time. Synchronization of the signal scanning processes includes synchronization of signal scanning periods and synchronization of start moments in scanning signal periods.

According to the method provided in this embodiment of this disclosure, because the plurality of electronic devices connected to the gateway device perform signal scanning synchronously, that is, the plurality of electronic devices wake up and sleep synchronously, after the gateway device sends the control instruction, the plurality of electronic devices can receive the control instruction synchronously, and perform a corresponding control operation, so that user experience can be improved.

It should be noted that, in this embodiment, in processes such as simultaneous sending, simultaneous receiving, and simultaneous execution, “simultaneous” may be understood as that a time difference is within a preset range, for example, 5 ms, 10 ms, or 20 ms.

In some implementations, that the gateway device is configured to determine the target scanning period of the plurality of electronic devices includes: obtaining a plurality of signal scanning periods respectively corresponding to the plurality of electronic devices; determining a plurality of duty cycles respectively corresponding to the plurality of signal scanning periods, where the duty cycle is a ratio of a wake-up time to a sleep time in the signal scanning period; determining a smallest duty cycle in the plurality of duty cycles; and determining N times a signal scanning period corresponding to the smallest duty cycle as the target scanning period, where N>0.

A larger duty cycle indicates a longer wake-up time of the electronic device and higher power consumption. Therefore, N times the signal scanning period corresponding to the smallest duty cycle is determined as the target scanning period, so that power consumption is not increased when the electronic device does not work, and a case in which the electronic device suddenly starts due to an excessively large current because of excessively high-power consumption can be avoided.

In some implementations, that the gateway device is configured to determine the target scanning period of the plurality of electronic devices includes: determining a preset signal scanning period as the target scanning period of the plurality of electronic devices. It should be noted that the preset signal scanning period is generally universal, that is, is applicable to most electronic devices.

In some implementations, the plurality of electronic devices includes at least one first electronic device and a second electronic device. When the gateway device is connected to the at least one first electronic device but is not connected to the second electronic device, the at least one first electronic device performs signal scanning synchronously based on a historical scanning period; and after the gateway device is connected to the second electronic device, and before the gateway device synchronizes the signal scanning processes of the plurality of electronic devices, the second electronic device is continuously in a wake-up state within a preset time.

In some implementations, that the gateway device is configured to synchronize the signal scanning processes of the plurality of electronic devices based on the target scanning period includes: sending a first synchronization instruction to the plurality of electronic devices simultaneously when the plurality of electronic devices are all in the wake-up state, where the first synchronization instruction indicates the electronic device to perform signal scanning based on the target scanning period.

In some implementations, that the gateway device is configured to synchronize the signal scanning processes of the plurality of electronic devices based on the target scanning period includes that the gateway device is configured to send a first synchronization instruction to the second electronic device at a first moment if the historical scanning period is the same as the target scanning period, where the first synchronization instruction indicates the electronic device to perform signal scanning based on the target scanning period.

In addition, the second electronic device is configured to if the first moment is before a start of a wake-up time in a next historical scanning period, and a time difference between the first moment and a start moment of the wake-up time is T_{delay}, after the first synchronization instruction is received, perform signal scanning based on the target scanning period, where T_{delay} is a delay of the first synchronization instruction from the gateway device to the second electronic device. Alternatively, if the first moment is within a wake-up time in the historical scanning period, and a time difference between the first moment and a start moment of the wake-up time is T₂, after the first synchronization instruction is received, perform signal scanning based on the target scanning period, and shorten a wake-up time in a first target scanning period by T_{delay}+Tₓ, where Tₓ is a preset value.

According to the method provided in this embodiment, when the gateway device synchronizes the signal scanning processes of the plurality of electronic devices, impact of a sending delay of the first synchronization instruction on synchronization precision can be eliminated, to provide a synchronization degree of signal scanning performed by the plurality of electronic devices.

In some implementations, the gateway device is further configured to send a second synchronization instruction to the plurality of electronic devices simultaneously at an interval of a preset time after sending the first synchronization instruction, where the second synchronization instruction indicates the electronic device to restart signal scanning based on the target scanning period. The electronic device is further configured to restart signal scanning based on the target scanning period in response to the second synchronization instruction.

According to the method provided in this embodiment of this disclosure, the gateway device may control all the electronic devices added to the gateway device to perform long-term signal scanning synchronously, so that all the electronic devices can synchronously receive the control instruction of the gateway device.

In some implementations, the gateway device is further configured to: if the plurality of electronic devices are in a same device set, create bitmap information of the device set, where the bitmap information includes a plurality of bits, and an i^{th} bit indicates status information of an electronic device whose device ID is i; after each electronic device is added to the device set, allocate a device ID to the electronic device; and register, at a bit corresponding to the device ID, the status information of the electronic device corresponding to the device ID.

The status information includes a join state and an exit state. The join state indicates that the electronic device is in the device set, and the exit state indicates that the electronic device has been added to the device set but is currently deleted from the device set. For example, the device set may be a control group or a device set corresponding to a control scene.

In this embodiment of this disclosure, the electronic device may learn a status of the electronic device based on the bitmap information, to manage and control the electronic device.

In some implementations, the plurality of electronic devices is further configured to, after an instruction sent by the gateway device is received, sequentially send response messages to the gateway device in ascending order of device IDs.

Specifically, each of the plurality of electronic devices may be configured to: after the instruction sent by the gateway device is received, send a response message to the gateway device at a K^{th} second, where K=T×device ID, and T is a preset value.

In this embodiment of this disclosure, the gateway device can receive the response message of each single-live-wire device in a time division manner, thereby helping reduce a case in which uplink network congestion occurs on the gateway device.

According to a second aspect, an embodiment of this disclosure provides a device control method, applied to a gateway device, where the gateway device is connected to a plurality of electronic devices, and the method includes: determining a target scanning period of the plurality of electronic devices, where the target scanning period includes a wake-up time and a sleep time; synchronizing signal scanning processes of the plurality of electronic devices based on the target scanning period; and sending a control instruction to the plurality of electronic devices when the plurality of electronic devices are all within the wake-up time in the target scanning period.

In some implementations, the determining a target scanning period of the plurality of electronic devices includes: obtaining a plurality of signal scanning periods respectively corresponding to the plurality of electronic devices; determining a plurality of duty cycles respectively corresponding to the plurality of signal scanning periods, where the duty cycle is a ratio of a wake-up time to a sleep time in the signal scanning period; determining a smallest duty cycle in the plurality of duty cycles; and determining N times a signal scanning period corresponding to the smallest duty cycle as the target scanning period, where N>0.

In some implementations, the determining a target scanning period of the plurality of electronic devices includes: determining a preset signal scanning period as the target scanning period of the plurality of electronic devices.

In some implementations, the plurality of electronic devices includes at least one first electronic device and a second electronic device. Before the determining a target scanning period of the plurality of electronic devices, the method further includes: connecting to the second electronic device in a process in which the at least one first electronic device performs signal scanning synchronously based on a historical scanning period, where after the second electronic device is connected and before the signal scanning processes of the plurality of electronic devices are synchronized, the second electronic device is continuously in a wake-up state within a preset time.

In some implementations, the synchronizing signal scanning processes of the plurality of electronic devices based on the target scanning period includes: sending a first synchronization instruction to the plurality of electronic devices simultaneously when the plurality of electronic devices are all in the wake-up state, where the first synchronization instruction indicates the electronic device to perform signal scanning based on the target scanning period.

In some implementations, the synchronizing signal scanning processes of the plurality of electronic devices based on the target scanning period includes sending a first synchronization instruction to the second electronic device at a first moment if the historical scanning period is the same as the target scanning period, where the first synchronization instruction indicates the electronic device to perform signal scanning based on the target scanning period.

The first moment is before a start of a wake-up time in a next historical scanning period, a time difference between the first moment and a start moment of the wake-up time is T_{delay}, and T_{delay} is a delay of the first synchronization instruction from the gateway device to the second electronic device.

Alternatively, the first moment is within a wake-up time in the historical scanning period, a time difference between the first moment and a start moment of the wake-up time is Tₓ, and Tₓ is a preset value.

In some implementations, the synchronizing signal scanning processes of the plurality of electronic devices based on the target scanning period further includes: sending a second synchronization instruction to the plurality of electronic devices simultaneously at an interval of a preset time after the first synchronization instruction is sent, where the second synchronization instruction indicates the electronic device to restart signal scanning based on the target scanning period.

In some implementations, if the plurality of electronic devices is in a same device set, the method further includes creating bitmap information of the device set, where the bitmap information includes a plurality of bits, and an i^{th} bit indicates status information of an electronic device whose device ID is i. After each electronic device is added to the device set, allocating a device ID to the electronic device; and registering, at a bit corresponding to the device ID, the status information of the electronic device corresponding to the device ID.

In some implementations, the method further includes: sequentially receiving, in ascending order of device IDs, response messages returned by the plurality of electronic devices.

According to a third aspect, an embodiment of this disclosure further provides a device control method, applied to an electronic device. The method includes: receiving a first synchronization instruction, where the first synchronization instruction carries a target scanning period, and the target scanning period is determined based on signal scanning periods of a plurality of electronic devices in a control network in which the electronic device is located; performing signal scanning based on the target scanning period; receiving a control instruction within a wake-up time in the target scanning period; and executing the control instructions.

In some implementations, the method further includes: after the first synchronization instruction is received, performing signal scanning based on the target scanning period, and shortening a wake-up time in a first target scanning period by T_{delay}+Tₓ, where T_{delay} is a delay of the first synchronization instruction from a gateway device to the electronic device, and Tₓ is a value notified by the gateway device or a preset value.

In some implementations, the method further includes: receiving a second synchronization instruction, where the second synchronization instruction carries the target scanning period; and restarting signal scanning based on the target scanning period in response to the second synchronization instruction.

In some implementations, the method further includes: after the instruction sent by the gateway device is received, sending a response message to the gateway device at a K^{th} second, where K=T×device ID, and T is a preset value.

According to a fourth aspect, an embodiment of this disclosure provides a device control apparatus, used in a gateway device, where the apparatus includes: a period determining module, configured to determine a target scanning period of the plurality of electronic devices, where the target scanning period includes a wake-up time and a sleep time; a period synchronization module, configured to synchronize signal scanning processes of the plurality of electronic devices based on the target scanning period; and a sending module, configured to send a control instruction to the plurality of electronic devices simultaneously when the plurality of electronic devices are all within the wake-up time in the target scanning period.

According to a fifth aspect, an embodiment of this disclosure further provides a device control apparatus, used in an electronic device, where the apparatus includes: a receiving module, configured to receive a first synchronization instruction, where the first synchronization instruction carries a target scanning period, and the target scanning period is determined based on signal scanning periods of a plurality of electronic devices in a control network in which the electronic device is located; a scanning control module, configured to perform signal scanning based on the target scanning period; and an execution module, configured to execute a received control instruction.

According to a sixth aspect, an embodiment of this disclosure provides a gateway device. The gateway device includes a memory, a processor, and a computer program that is stored in the memory and that can run on the processor. When executing the computer program, the processor implements the method according to the second aspect.

According to a seventh aspect, an embodiment of this disclosure provides an electronic device. The electronic device includes a memory, a processor, and a computer program that is stored in the memory and that can run on the processor. When executing the computer program, the processor implements the method according to the second aspect.

According to an eighth aspect, an embodiment of this disclosure provides a computer-readable storage medium. The computer-readable storage medium stores a computer program. When the computer program is executed by a processor, the method according to the second aspect or the third aspect is implemented.

According to a ninth aspect, an embodiment of this disclosure provides a chip. The chip includes a processor and a memory. The memory stores a computer program. When the computer program is executed by the processor, the method according to the second aspect or the third aspect is implemented.

According to a tenth aspect, an embodiment of this disclosure provides a computer program file. The computer program file includes a program, and when the program is run by an electronic device, the electronic device is enabled to implement the method according to the second aspect or the third aspect.

It may be understood that, for beneficial effects of the second aspect to the tenth aspect, refer to related descriptions in the first aspect. Details are not described herein again.

### BRIEF DESCRIPTION OF DRAWINGS

FIG. 1 is a diagram of a structure of a smart home network according to an embodiment;

FIG. 2 is a diagram of a structure of a smart home device according to an embodiment;

FIG. 3 is a diagram of a structure of a neutral-live-wire device according to an embodiment;

FIG. 4 is a flowchart of controlling a neutral-live-wire device according to an embodiment;

FIG. 5 is a diagram of a structure of a single-live-wire device according to an embodiment;

FIG. 6 is a flowchart of controlling a single-live-wire device according to an embodiment;

FIG. 7A to FIG. 7C are diagrams of controlling light groups by a gateway device in different scenes;

FIG. 8 is a flowchart of controlling a group/scene according to an embodiment;

FIG. 9 is a flowchart of controlling a group/scene according to an embodiment;

FIG. 10 is a schematic flowchart of synchronizing signal scanning processes according to an embodiment;

FIG. 11A to FIG. 11C are diagrams of sending a first synchronization instruction by a gateway device according to different embodiments;

FIG. 12 is a schematic flowchart of a device control method according to an embodiment;

FIG. 13 is a schematic flowchart of a device control method according to an embodiment;

FIG. 14 is a diagram of each electronic device responding to a gateway device in a time-division manner;

FIG. 15 is a diagram of a device control apparatus according to an embodiment;

FIG. 16 is a diagram of a device control apparatus according to another embodiment; and

FIG. 17 is a diagram of a structure of a chip according to an embodiment.

### DESCRIPTION OF EMBODIMENTS

Technical solutions provided in embodiments of this disclosure are described below with reference to accompanying drawings.

It should be understood that, in descriptions of embodiments of this disclosure, “/” indicates “or”, unless otherwise specified. For example, A/B may indicate A or B. The term “and/or” in this specification describes only an association relationship between associated objects, and indicates that three relationships may exist. For example, A and/or B may indicate the following three cases: Only A exists, both A and B exist, and only B exists.

The terms “first” and “second” in embodiments are merely intended for a purpose of description, and shall not be understood as an indication or an implication of relative importance or an implicit indication of a quantity of indicated technical features. Therefore, a feature limited by “first” or “second” may explicitly or implicitly include one or more features. In the descriptions of embodiments, unless otherwise specified, “a plurality of” means two or more.

With development of computer technologies, smart home is increasingly widely used in people's life. In a smart home scene, various electronic devices can be connected together based on an Internet of Things technology, to form a smart home network.

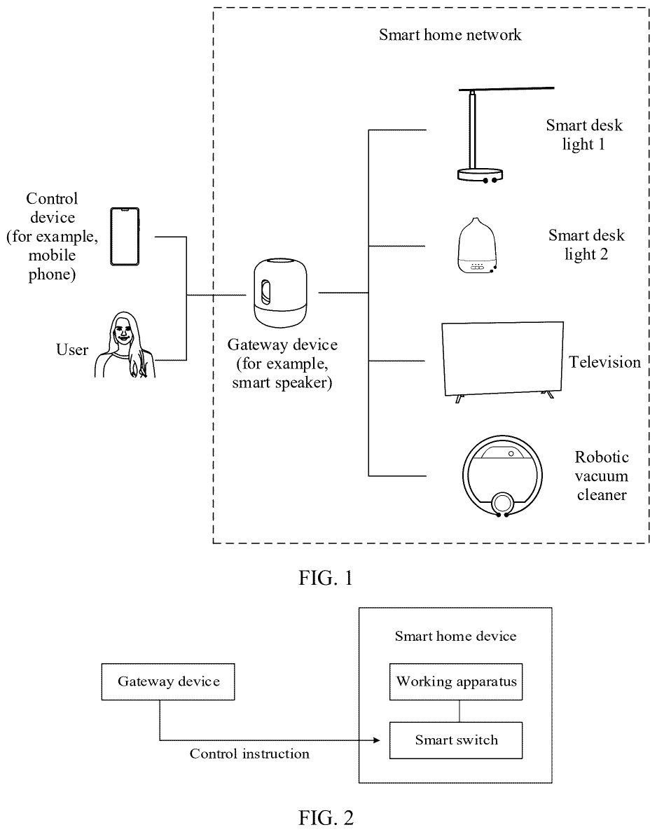

FIG. 1 is a diagram of a structure of a smart home network according to an embodiment of this disclosure. Refer to FIG. 1. The smart home network includes a gateway device and a smart home device. The gateway device and each smart home device may be connected to each other based on a wireless communication technology like a BLUETOOTH low energy mesh (BLE Mesh), a WI-FI technology, BLUETOOTH (BT), ZIGBEE, an ultra-wideband (UWB), or near field communication (NFC). The smart home devices may be connected or not connected.

The gateway device can intelligently manage and control each smart home device in the smart home network based on an instruction of a control device or a user. For example, the gateway device may control, based on a voice instruction or a touch operation of the user, each smart home device to be turned on/off. For another example, the gateway device may adjust brightness of a smart desk light, adjust a working mode and a temperature of an air conditioner, or control an intelligent lock to unlock based on a control instruction of the control device.

In this embodiment, the gateway device may be a dedicated gateway device, a router, a smart speaker, or the like. The smart home device may be a smart desk light, a smart ceiling light, a television, a sound box, a headset, an air purifier, a refrigerator, an air conditioner, a robotic vacuum cleaner, a camera, a projector, a router, a power socket, a router, a humidifier, a socket, an intelligent lock, a water purifier, a sensor, a treadmill, or the like. The main control device may be a mobile phone, a tablet computer (pad), a computer with a wireless transceiver function, a wearable device (like a smartwatch), a netbook, a personal digital assistant (PDA), or the like. A type of each electronic device is not specifically limited in this embodiment.

FIG. 2 is a diagram of a structure of a smart home device according to an embodiment of this disclosure. Refer to FIG. 2. The smart home device includes a working apparatus and an intelligent switch. The intelligent switch can receive a control instruction sent by a gateway device, and control, based on the control instruction, the working apparatus to be powered on/off. The working apparatus can work after power-on and stop working after power-off. It should be understood that different smart home devices have different working apparatuses. For example, a working apparatus of a smart desk light is a light emitting apparatus (like a light bulb), and a working apparatus of an air conditioner is a cooling/heating apparatus.

Currently, the smart home device includes a neutral-live-wire device and a single-live-wire device. In this embodiment of this disclosure, an electronic device (for example, a smart home device) that uses a neutral-live-wire switch is referred to as a neutral-live-wire device, and an electronic device (for example, a smart home device) that uses a single-live-wire switch is referred to as a single-live-wire device. The neutral-live-wire device is common in life. The single-live-wire device is usually used in a scene without a neutral wire, for example, an old house without a neutral wire, or a new house without a neutral wire to save costs.

The following separately describes the neutral-live-wire device and the single-live-wire device in detail.

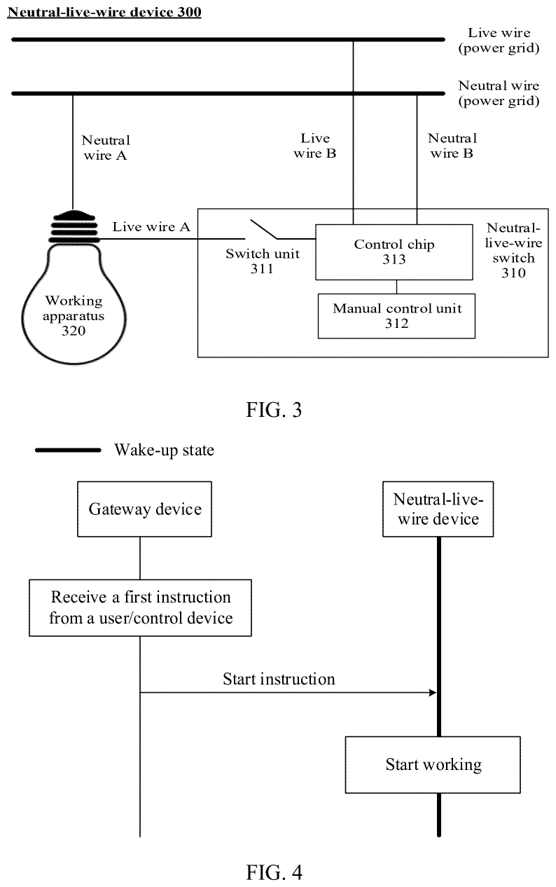

FIG. 3 is a diagram of a structure of a neutral-live-wire device according to an embodiment of this disclosure. Refer to FIG. 3. The neutral-live-wire device 300 includes a neutral-live-wire switch 310 and a working apparatus 320. The neutral-live-wire switch 310 can control, based on a control instruction of a user or a gateway device, whether the working apparatus 320 works, to control whether the neutral-live-wire device works.

The neutral-live-wire switch 310 includes a switch unit 311, a manual control unit 312, and a control chip 313.

The switch unit 311 is mounted on a live wire A, and controls connection and disconnection of the live wire A. When the switch unit 311 is turned on, the live wire A is connected. When the switch unit 311 is turned off, the live wire A is disconnected.

The manual control unit 312 is connected to the control chip 313, and can send a control instruction to the control chip 313 based on a user operation. In an example, the manual control unit 312 is a switch button. In response to a pressing operation of the user, the switch button sends a control instruction to the control chip 313, and the control instruction is used to control the switch unit 311 to be turned off or turned on. It can be understood that the manual control unit 312 enables the user to directly control the turn-on and turn-off of the neutral-live-wire device 300.

The control chip 313 is connected to a neutral wire of a power grid through a neutral wire B, is connected to a live wire of the power grid through a live wire B, and keeps in a power-on state. In the power-on state, the control chip 313 can receive a control instruction sent by the gateway device or the manual control unit 312, and control, based on the control instruction, the switch unit 311 to be turned on or turned off. It may be understood that when the switch unit 311 is turned on, the neutral-live-wire switch 310 is turned on; or when the switch unit 311 is turned off, the neutral-live-wire switch 310 is turned off.

The working apparatus 320 is connected to the neutral wire of the power grid through a neutral wire A, and is connected to the live wire of the power grid through the live wire A, the neutral-live-wire switch 310, and the live wire B sequentially. After the neutral-live-wire switch 310 is turned on, the live wire A is connected, the working apparatus 320 is powered on and works, and the neutral-live-wire device 300 works. After the neutral-live-wire switch 310 is turned off, the live wire A is disconnected, the working apparatus 320 is powered off and stops working, and the neutral-live-wire device 300 stops working.

Based on the foregoing descriptions, it can be learned that, when the neutral-live-wire device 300 does not work, the working apparatus 320 is powered off and does not work, but the neutral-live-wire switch 310 is continuously in a wake-up state, can be powered on and work normally, and scan and receive a control instruction of the gateway device. For example, the neutral-live-wire device can continuously scan and receive a start instruction sent by the gateway device, and start working.

FIG. 4 is a flowchart of controlling a neutral-live-wire device according to an embodiment of this disclosure, and relates to a process in which a gateway device controls the neutral-live-wire device to start. Refer to FIG. 4. In response to a first instruction of a user/control device, the gateway device broadcasts a start instruction in a smart home network. The start instruction indicates to turn on an intelligent switch of a target neutral-live-wire device, and carries unique identification information of the target neutral-live-wire device in the smart home network. After receiving the start instruction, each neutral-live-wire device needs to determine whether the unique identification information carried in the start instruction is the same as unique identification information of the neutral-live-wire device. If the unique identification information carried in the start instruction is the same as the unique identification information of the neutral-live-wire device, a neutral-live-wire switch is turned on to power on a working apparatus and control the working apparatus to work. If the unique identification information carried in the start instruction is different from the unique identification information of the neutral-live-wire device, the neutral-live-wire device ignores the start instruction. It may be understood that only the target neutral-live-wire device can turn on the intelligent switch based on the start instruction, and power on the working apparatus of the target neutral-live-wire device.

For example, the user may turn on a smart desk light through voice “Hey Celia, turn on the smart desk light”. After receiving the voice, the gateway device broadcasts a start instruction in the smart home network, where the start instruction carries unique identification information of the smart desk light. After receiving the start instruction, a neutral-live-wire switch of the smart desk light detects that unique identification information of the start instruction is the same as the unique identification information of the smart desk light. Therefore, the neutral-live-wire switch is turned on, and a light emitting apparatus is powered on and illuminated.

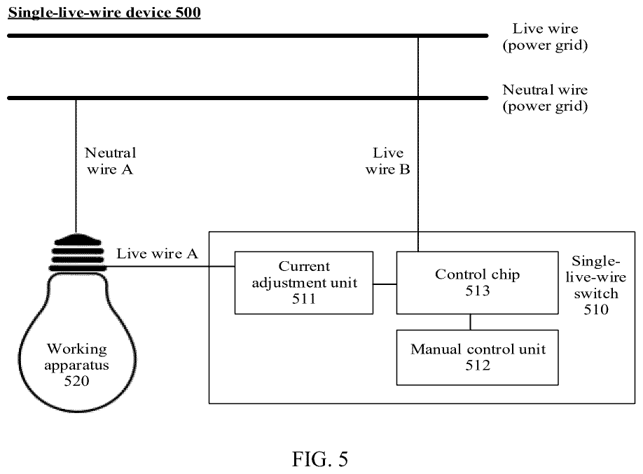

FIG. 5 is a diagram of a structure of a single-live-wire device according to an embodiment of this disclosure. Refer to FIG. 5. The single-live-wire device 500 includes a single-live-wire switch 510 and a working apparatus 520. The single-live-wire switch 510 can control, based on a control instruction of a user or a gateway device, whether the working apparatus 520 works, to control whether the single-live-wire device 500 works.

The single-live-wire switch 510 includes a current adjustment unit 511, a manual control unit 512, and a control chip 513.

The current adjustment unit 511 is configured to adjust a current of a circuit in which the current adjustment unit 511 is located. For example, the current adjustment unit 511 is a variable resistor. The current adjustment unit 511 may decrease the current in the circuit by increasing a resistance of the current adjustment unit 511, or increase the current in the circuit by reducing a resistance of the current adjustment unit 511. A specific form of the current adjustment unit 511 is not limited in this embodiment.

The manual control unit 512 is connected to the control chip 513, and can send a control instruction to the control chip 513 based on a user operation. In an example, the manual control unit 512 may be a switch button. In response to a pressing operation of the user, the switch button sends a control instruction to the control chip 513, and the control instruction is used to control the current adjustment unit 511 to adjust the current in the circuit. It can be understood that the manual control unit 512 enables the user to directly control turn-on and turn-off of the single-live-wire device 500.

The control chip 513 is connected to a neutral wire of a power grid through the current adjustment unit 511, a live wire A, and a neutral wire A sequentially, and is connected to a live wire of the power grid through a live wire B. It can be seen that the neutral wire A, the working apparatus 520, the live wire A, the current adjustment unit 511, the control chip 513, and the live wire B are on a same current path (circuit 1), all these components are in a power-on state, and currents are the same at a same moment. In the power-on state, the control chip 513 can receive a control instruction sent by the gateway device/manual control unit 512, and control, based on the control instruction, the current adjustment unit 511 to adjust a magnitude of a current of the circuit 1.

In this embodiment, the single-live-wire switch 510 adjusts the current in the circuit 1 through the current adjustment unit 511, and controls a current I that flows through the working apparatus 520, to control a working state of the working apparatus 520. When a value of the current I is close to a rated working current (for example, 10 amperes A) of the working apparatus 520, it may be considered that the single-live-wire switch is “turned-on” and the working apparatus 520 works normally; or when a value of the current I is less than a threshold (for example, 100 milliamperes mA), it may be considered that the single-live-wire switch is “turned-off” and the working apparatus 520 stops working. It should be noted that, in the single-live-wire device, there is no switch that actually controls the connection and disconnection of the line. The circuit 1 is always in a connected state, and a current flows through the circuit 1, but the current is different in magnitude.

The working apparatus 520 is connected to the neutral wire of the power grid through the neutral wire A, and is connected to the live wire of the power grid through the live wire B, the single-live-wire switch 510, and the live wire A sequentially. After the single-live-wire switch 510 is “turned on”, the current of the working apparatus 520 reaches the rated current and starts to work, that is, the single-live-wire device 500 works. After the single-live-wire switch 510 is “turned off”, the current of the working apparatus 520 is less than the current threshold and stops working, that is, the single-live-wire device 500 stops working.

Based on the foregoing descriptions, it can be learned that, when the single-live-wire device 500 does not work, the working apparatus 520 and the single-live-wire switch 510 actually maintain a power-on state with a small current. Therefore, both the working apparatus 520 and the single-live-wire switch 510 have specific power consumption. To reduce power consumption, the single-live-wire switch enters a light sleep state and works in an intermittent wake-up and sleep manner. In other words, each time after the single-live-wire switch wakes up and works for a period of time, the single-live-wire switch sleeps for a period of time. For example, each time after the single-live-wire switch wakes up and works for 60 ms, the single-live-wire switch sleeps for 120 ms. In an example, in a wake-up and working time period, the single-live-wire switch 510 works at a rated current (for example, 100 mA), and scans and receives a control instruction of the gateway device. However, within a sleep time period, the single-live-wire switch 510 remains in the sleep state with a smaller current (for example, 1 mA), and does not scan or receive a control instruction. It can be understood that, because the single-live-wire switch 510 and the working apparatus 520 are in a series connection relationship, and the currents of the single-live-wire switch 510 and the working apparatus 520 are the same. When the single-live-wire switch 510 is in the sleep state, the current of the working apparatus 520 is also reduced (for example, reduced to 1 mA), thereby achieving an objective of reducing power consumption of the working apparatus 520.

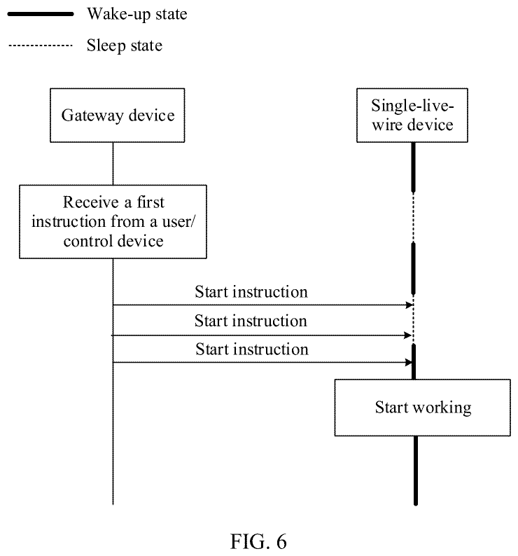

FIG. 6 is a flowchart of controlling a single-live-wire device according to an embodiment of this disclosure, and relates to a process in which a gateway device controls the single-live-wire device to start. Refer to FIG. 6. Control of the gateway device for the single-live-wire device is basically the same as that for the neutral-live-wire device. A difference lies in that the single-live-wire device scans a signal in a periodic wake-up and sleep manner. When the gateway device sends a start instruction, the single-live-wire device may be in a wake-up state and is scanning and receiving the start instruction, or may be in a sleep state and temporarily not scan and receive a signal. Therefore, the gateway device needs to send the start instruction a plurality of times to ensure that a target single-live-wire device receives the start instruction, and the target single-live-wire device starts.

Based on a smart home network, the gateway device may group added smart home devices into groups and scenes. Each group/scene corresponds to a device set. The device set includes one or more smart home devices. The gateway device may simultaneously control, based on one instruction of a user or the gateway device, all smart home devices in the group to be turned on/off.

Types of all electronic devices in a group are generally the same. For example, all electronic devices are lights, air conditioners, or electric curtains. The gateway device may automatically form different groups based on types of added electronic devices, so that the user controls the electronic devices by the groups.

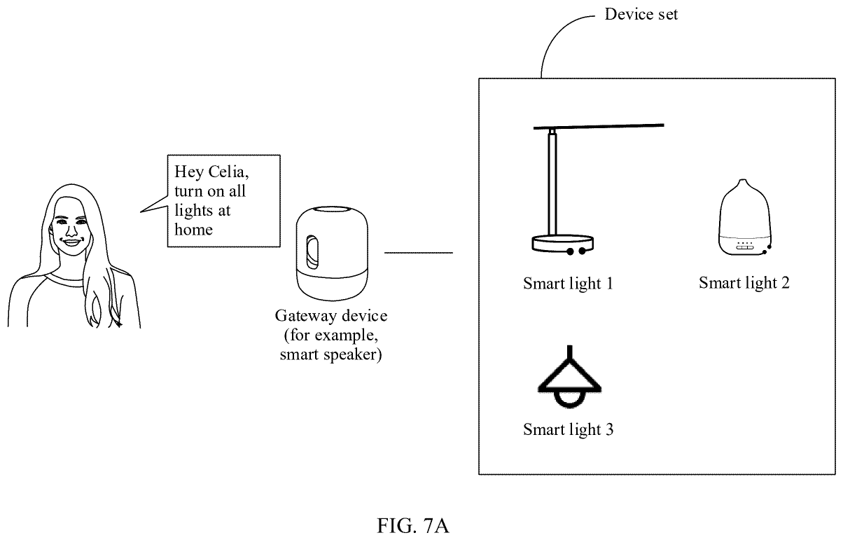

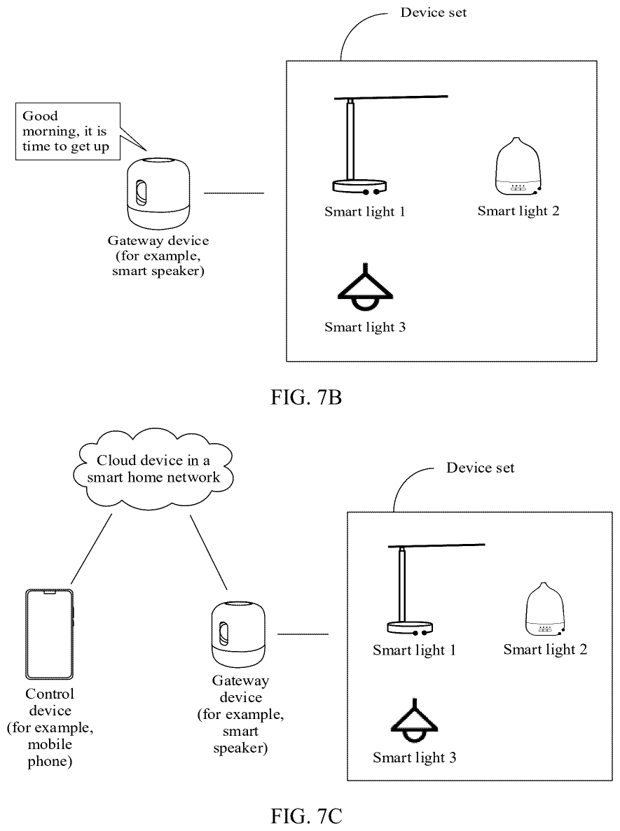

For example, a light group includes a smart light 1, a smart light 2, and a smart light 3. Refer to FIG. 7A. The gateway device may control, based on a voice instruction “Hey Celia, turn on all lights at home” of the user, all of the smart light 1, the smart light 2, and the smart light 3 in the light group to be turned on. Alternatively, refer to FIG. 7B. When a preset time point (for example, 6:30 a.m.) arrives, the gateway device may automatically control all of the smart light 1, the smart light 2, and the smart light 3 in the light group to be turned on. Alternatively, refer to FIG. 7C. If a control device (for example, a mobile phone) is connected to the gateway device through a cloud device, the control device may turn on all of the smart light 1, the smart light 2, and the smart light 3 in the light group based on an operation performed by the user on the control device. For example, the operation performed by the user on the control device may be tapping, in an AI LIFE application, a control widget corresponding to a target scene/target group.

Types of all electronic devices in a scene may be the same or may be different. The user may create a scene based on a specific requirement and add a corresponding device to the scene, to control all electronic devices in the scene simultaneously.

A going-home scene is used as an example. The user may add electronic devices such as an entryway light, a living room light, and a living room air conditioner in the going-home scene. After detecting a going-home trigger condition, the gateway device controls all electronic devices in the going-home scene to be turned on. For example, the going-home trigger condition may be: detecting that an intelligent lock is opened, detecting a voice control instruction “Hey Celia, I am home” of the user, or receiving an instruction that is sent by the control device (for example, the mobile phone) and that is used to enable the going-home scene.

An electronic device in a group/scene may be a neutral-live-wire device or a single-live-wire device. The following separately describes, with respect to two cases in which electronic devices in the group/scene are a neutral-live-wire device and a single-live-wire device, a case in which the gateway device simultaneously controls all electronic devices in the group/scene to work.

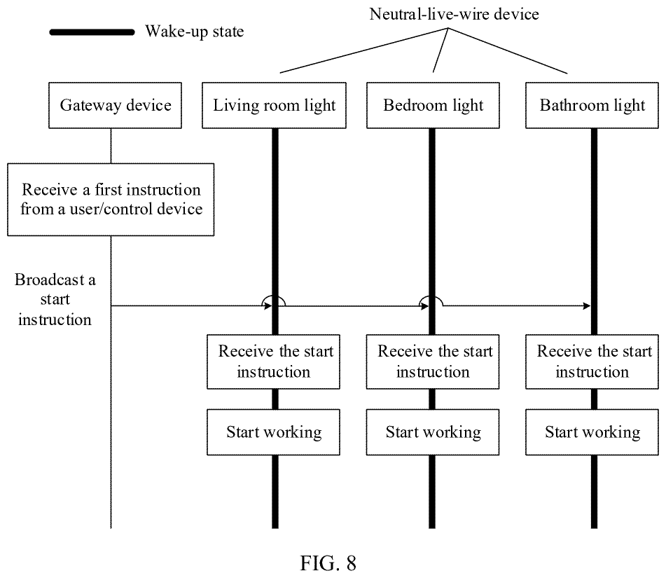

FIG. 8 is a flowchart of controlling a group/scene according to an embodiment of this disclosure, and relates to a process in which a gateway device controls the group/scene when all electronic devices in the group/scene are neutral-live-wire devices. For example, the electronic devices in the scene/group include a living room light, a bedroom light, and a bathroom light. Because all these electronic devices are neutral-live-wire devices, and are continuously in a wake-up state to scan and receive signals, after the gateway device sends a start instruction, the neutral-live-wire devices can receive the control instruction and start working simultaneously. In other words, the living room light, the bedroom light, and the bathroom light can be turned on simultaneously.

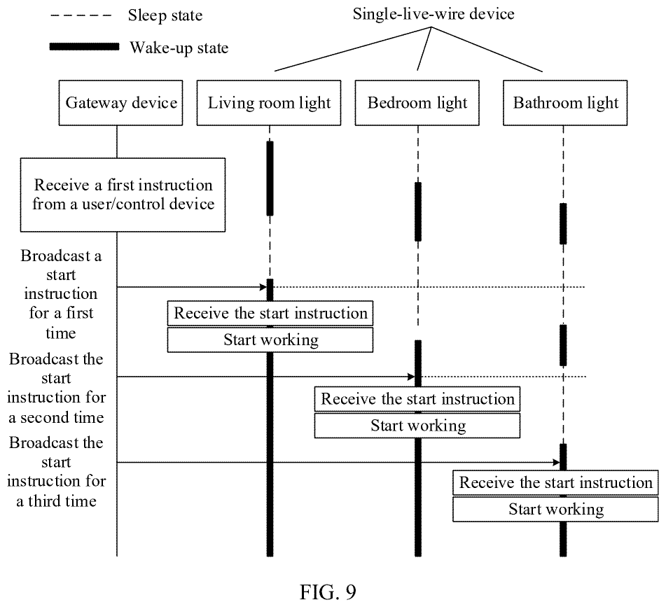

FIG. 9 is a flowchart of controlling a group/scene according to an embodiment of this disclosure, and relates to a process in which a gateway device controls the group/scene when all electronic devices in the group/scene are single-live-wire devices. For example, the electronic devices in the scene/group include a living room light, a bedroom light, and a bathroom light. All these electronic devices are single-live-wire devices, and signal scanning periods of different single-live-wire devices are different. At a same moment, some single-live-wire devices are in a wake-up state, and can scan and receive a control instruction of the gateway device, and some single-live-wire devices are in a sleep state, and cannot scan and receive a control instruction of the gateway device. Therefore, after the gateway device sends a start instruction, the single-live-wire devices in the intelligent control group/scene may not receive the control instruction simultaneously, and cannot start working simultaneously. In other words, the living room light, the bedroom light, and the bathroom light may not be turned on simultaneously, but may be turned on in sequence, resulting in poor user experience.

In view of this, an embodiment of this disclosure provides a device control method. According to the method, a plurality of electronic devices in a group/scene can be controlled to wake up and sleep simultaneously, so that all the electronic devices in the group/scene receive a control instruction simultaneously, and start working based on the control instruction simultaneously. This improves user experience.

The electronic device to which the device control method provided in this embodiment is applicable may also be referred to as a light sleep device. When the electronic device does not work, an intelligent switch of the electronic device is in a periodic wake-up and sleep state. For example, the electronic device may be a single-live-wire device, a battery-powered device, or a neutral-live-wire device that is set to be in a periodic wake-up and sleep state. This is not specifically limited in this embodiment.

The following describes the device control method provided in this embodiment by using an example in which the electronic device is a single-live-wire device. Specifically, the device control method relates to (1) synchronization of signal scanning processes of a plurality of single-live-wire devices; and (2) a device control process.

### (1) Synchronization of Signal Scanning Processes of Single-Live-Wire Devices

If only one single-live-wire device has been added to the gateway device, the gateway device may not need to intervene in a signal scanning process of the single-live-wire device. Alternatively, the gateway device may control the single-live-wire device to perform signal scanning in a signal scanning period of the single-live-wire device or a preset target scanning period starting from a preset time point, so that the gateway device masters a signal scanning situation of the single-live-wire device.

If a plurality of single-live-wire devices have been added to the gateway device, because the plurality of single-live-wire devices usually perform signal scanning at different paces, signal scanning processes of the plurality of the single-live-wire devices need to be synchronized. In this embodiment, synchronization of signal scanning processes of the plurality of single-live-wire devices includes: synchronization of signal scanning periods and synchronization of start moments in the signal scanning periods. After the signal scanning processes are synchronized, the plurality of single-live-wire devices wake up and sleep at a same pace. To be specific, the plurality of single-live-wire devices wake up simultaneously to scan the control instruction sent by the gateway device, and sleep simultaneously after the plurality of single-live-wire devices wake up for a preset time to stop scanning the control instruction.

In a smart home network, one gateway device may be connected to and manage a plurality of single-live-wire devices. Based on this, the gateway device may synchronize signal scanning periods of all single-live-wire devices managed by the gateway device as a whole, so that all the single-live-wire devices in the smart home network wake up and sleep at a same pace. In addition, after some single-live-wire devices in the smart home network form a group/scene, signal scanning periods of all single-live-wire devices in the group/scene may be synchronized, so that all the single-live-wire devices in the group/scene wake up and sleep at a same pace.

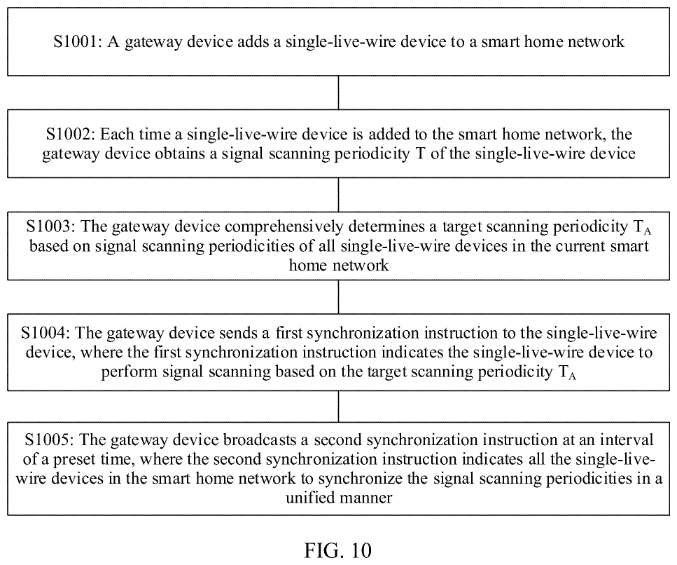

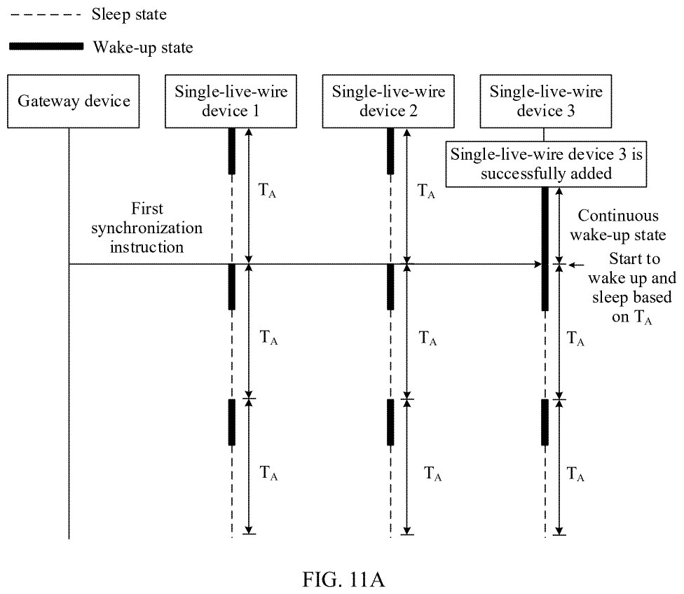

FIG. 10 is a schematic flowchart of synchronizing signal scanning processes according to an embodiment of this disclosure, and relates to related content of synchronizing, by a gateway device, signal scanning processes of all single-live-wire devices in a smart home network each time a single-live-wire device is added to the smart home network. Specifically, the following steps S1001 to S1005 are included.

S1001: The gateway device adds a single-live-wire device to the smart home network.

For example, the gateway device is a mobile phone. The mobile phone may add a single-live-wire device to the smart home network through an AI LIFE application. Alternatively, for example, the gateway device is a smart speaker. The smart speaker may add a single-live-wire device to the smart home network under control of a control device (for example, a mobile phone). A specific adding process is not described herein again.

Because there may be a plurality of gateway devices in the smart home network, and different gateway devices manage different smart home devices (including a single-live-wire device), in a process of adding a smart home device to the smart home network, the gateway device needs to send a gateway address to the smart home device.

In an example, the gateway device may send the gateway address through a following instruction.

| | |
|---|---|
| Attribute Type | Gateway address |
| | 2 bytes |

The smart home device needs to receive and store the gateway address of the gateway device, and in a subsequent working process, filter a received control instruction based on the gateway address, to avoid a problem of a multi-gateway conflict caused by execution of a control instruction sent by another gateway device. Specifically, the control instruction sent by the gateway device carries both an original address and a destination address. The original address is an address of the gateway device, and the destination address is an address of a target smart home device, for example, a public address (for example, 0xffff) of each smart home device in the smart home network, a group address of a device group, or a scene ID of a scene. After the smart home device receives the control instruction, and the gateway address (for example, a gateway address 1) carried in the control instruction is the same as a locally stored gateway address (for example, a gateway address 2), the smart home device determines that the gateway device that sends the control instruction is the gateway device corresponding to the smart home device, and the smart home device executes the control instruction. If the gateway address (for example, a gateway address 1) carried in the control instruction is different from a locally stored gateway address (for example, a gateway address 2), the smart home device determines that the gateway device that sends the control instruction is not the gateway device corresponding to the smart home device, and ignores the control instruction.

It should be noted that the control instruction may be various control instructions sent by the gateway device to the smart home device, including a first synchronization instruction, a second synchronization instruction, a start instruction, and the like that are shown below.

S1002: Each time a single-live-wire device is added to the smart home network, the gateway device obtains a signal scanning period T of the single-live-wire device.

After the gateway device successfully adds the single-live-wire device to the smart home network, the single-live-wire device may report information like a device attribute and the signal scanning period T of the single-live-wire device automatically or based on an indication of the gateway device. The device attribute indicates whether the single-live-wire device is a light sleep device. The signal scanning period includes a wake-up time and a sleep time. For example, a signal scanning period “60 ms/160 ms” indicates that a wake-up time of the single-live-wire device in each signal scanning period is 60 ms, and a sleep time is 160 ms. A signal scanning period “60 ms/180 ms” indicates that a wake-up time of the single-live-wire device in each signal scanning period is 60 ms, and a sleep time is 180 ms.

It should be understood that signal scanning periods of different single-live-wire devices may be the same or may be different. That signal scanning periods are the same means that wake-up times are the same and sleep times are the same, and that signal scanning periods are different means that wake-up times are different and/or sleep times are different. In addition, in a process in which the single-live-wire device wakes up and sleeps periodically, the single-live-wire device usually first wakes up and then sleeps. However, this is not limited in this embodiment. The single-live-wire device may alternatively first sleeps and then wakes up.

S1003: The gateway device comprehensively determines a target scanning period T_{A} based on signal scanning periods of all single-live-wire devices in the current smart home network.

Each time the gateway device successfully adds a single-live-wire device, the single-live-wire device sends a signal scanning period of the single-live-wire device to the gateway device. Therefore, the gateway device stores signal scanning periods of all the added single-live-wire devices, and can comprehensively determine the target scanning period T_{delay} based on these signal scanning periods.

If there is one single-live-wire device in the current smart home network, the gateway device may use a signal scanning period of the single-live-wire device as the target scanning period T_{A}.

If there are a plurality of single-live-wire devices in the current smart home network, the gateway device may comprehensively determine the target scanning period T_{A} based on signal scanning periods of all the single-live-wire devices.

In a possible implementation, the gateway device may determine duty cycles of the signal scanning periods of all the single-live-wire devices, and determine N times a signal scanning period corresponding to a smallest duty cycle as the target scanning period T_{A}, where N is a non-zero positive number, for example, N=1, N=10, or N=1/10.

It should be noted that the duty cycle of the signal scanning period is a ratio of a wake-up time to a sleep time in the signal scanning period. A larger duty cycle indicates a longer wake-up time of the single-live-wire device and higher power consumption of the single-live-wire device. N times the signal scanning period corresponding to the smallest duty cycle is determined as T_{A}, so that a case in which power consumption is increased when another single-live-wire device does not work can be avoided, and a case in which the single-live-wire device suddenly starts can be avoided. For example, if a duty cycle of a signal scanning period of a smart desk light is 6/16, and a duty cycle of the target scanning period T_{A} determined by the gateway device is 10/16, when the smart desk light is turned off (that is, a light bulb is turned off), if the smart desk light works based on T_{A}, power of the smart desk light increases, and a current that flows through the smart desk light increases, causing the light bulb to emit light. However, if the duty cycle of T_{A} is less than or equal to 6/16, when the smart desk light works based on T_{A}, power is not increased, and a case in which the light bulb emits light when the user does not turn on the light does not occur.

It should be noted that, each time the gateway device newly adds a single-live-wire device, the target scanning period T_{A} determined by the gateway device may change based on different single-live-wire devices. For example, a signal scanning period of a single-live-wire device 1 is T₁, and a signal scanning period of a single-live-wire device 2 is T₂. When the single-live-wire device 1 and the single-live-wire device 2 are added but a single-live-wire device 3 is not added by the gateway device, a target scanning period determined based on T₁ and T₂ is T_{A-old}, and the single-live-wire device 1 and the single-live-wire device 2 work synchronously based on T_{A-old}. On this basis, if the single-live-wire device 3 is newly added to the gateway device, and a signal scanning period of the single-live-wire device 3 is T₃, the gateway device needs to re-determine a target scanning period T_{A-new} based on T₁, T₂, and T₃. T_{A-old} and T_{A-new} may be the same or different.

Optionally, the gateway device may not perform S1002 and S1003. To be specific, the gateway device does not comprehensively determine the target scanning period T_{A} based on the signal scanning periods of all the single-live-wire devices added to the group/scene, but determines a preset signal scanning period as the target scanning period T_{A}. The preset signal scanning period is generally universal, that is, is applicable to most single-live-wire devices. For example, the preset signal scanning period is “60 ms/160 ms”.

S1004: The gateway device sends a first synchronization instruction to the single-live-wire device, where the first synchronization instruction indicates the single-live-wire device to perform signal scanning based on the target scanning period T_{A}.

According to a pre-configuration of the single-live-wire device, after being successfully added to the smart home network, the single-live-wire device is continuously in a wake-up state in a first clock period (for example, within 30 s), to receive the control instruction sent by the gateway device in time. Therefore, the gateway device may send the first synchronization instruction to the single-live-wire device in the first clock period, to control the single-live-wire devices to synchronize the signal scanning periods.

Optionally, if the single-live-wire device does not receive the first synchronization instruction in the first clock period, the single-live-wire device may restart one or more first clock periods, to wait for receiving the first synchronization instruction. If the restarted one or more first clock periods expire again, and the single-live-wire device still does not receive the first synchronization instruction, the single-live-wire device enters a sleep state, and starts to work in the signal scanning period of the single-live-wire device.

In an example, the first synchronization instruction sent by the gateway device may be as follows:

| | | | |
|---|---|---|---|
| op code | Gateway system time point | Wake-up time | Sleep time |
| 3 bytes | 4 bytes | Bytes | Bytes |

In the first synchronization instruction, the op code is identification information of a control instruction, and is specifically determined based on the pre-configuration. In an example, the op code may be D8027D. In addition, the gateway system time point is optional content. In other words, the first synchronization instruction may not carry the gateway system time point.

If a quantity of single-live-wire devices in the smart home network is equal to 1, that is, the gateway device is currently connected to only one single-live-wire device, the gateway device may send the first synchronization instruction to the single-live-wire device at any time point when the single-live-wire device wakes up. This is not limited in this embodiment.

If a quantity of single-live-wire devices in the smart home network is greater than 1, the gateway device may synchronize signal scanning processes of all single-live-wire devices in different manners based on whether T_{A-old} and T_{A-new} are the same. T_{A-old} is a target scanning period determined before the single-live-wire device is added, and T_{A-new} is a target scanning period determined after the single-live-wire device is added. The process is specifically described as follows.

For example, the signal scanning periods of the single-live-wire device 1, the single-live-wire device 2, and the single-live-wire device 3 are T₁, T₂, and T₃ respectively. The gateway device first adds the single-live-wire device 1 and the single-live-wire device 2, comprehensively determines T_{A-old} based on T₁ and T₂, and synchronizes the signal scanning processes of the single-live-wire device 1 and the single-live-wire device 2 based on T_{A-old}. On this basis, the single-live-wire device 3 is newly added to the gateway device, and T_{A-new} is comprehensively determined based on T₁, T₂, and T₃. With reference to cases in which T_{A-old} and T_{A-old} are the same or different, the following describes an example of a process in which the gateway device synchronizes the signal scanning processes of the single-live-wire device 1, the single-live-wire device 2, and the single-live-wire device 3 based on T_{A-old}.

### (1) T_{A-old} and T_{A-new} are the Same

In some implementations, if T_{A-old} and T_{A-new} are the same, the gateway device sends the first synchronization instruction only to the single-live-wire device 3, and does not send the first synchronization instruction to the single-live-wire device 1 and the single-live-wire device 2.

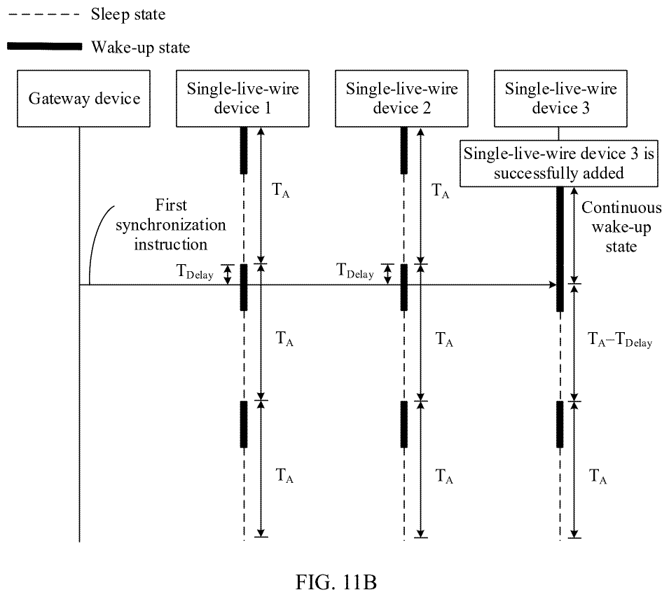

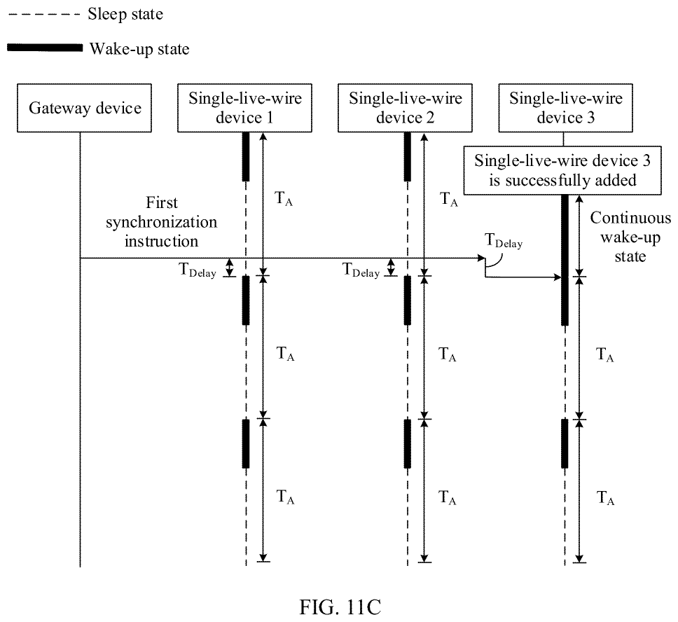

When a sending delay T_{delay} of the first synchronization instruction is not considered, for example, with reference to FIG. 11A, when the single-live-wire device 1 and the single-live-wire device 2 just start a new T_{A-old}, the gateway device sends the first synchronization instruction to the single-live-wire device 3, to indicate the single-live-wire device to wake up and sleep based on T_{A-new}. Because T_{A-old} and T_{A-new} are the same, and the single-live-wire device 1, the single-live-wire device 2, and the single-live-wire device 3 start a new round of signal scanning simultaneously, the single-live-wire device 1, the single-live-wire device 2, and the single-live-wire device 3 can perform signal scanning at a same pace.

When a sending delay T_{delay} of the first synchronization instruction is considered, to implement precise synchronization between different single-live-wire devices, the gateway device may send the first synchronization instruction to the electronic device 3 in any one of the following manners.

Manner 1: With reference to FIG. 11B, the gateway device may send the first synchronization instruction T_{delay} before the single-live-wire device 1 and the single-live-wire device 2 just start a new T_{A-old}. It may be understood that the first synchronization instruction sent by T_{delay} in advance may arrive at the single-live-wire device 3 when the single-live-wire device 1 and the single-live-wire device 2 just start a new T_{A-old}, so that the single-live-wire device 1, the single-live-wire device 2, and the single-live-wire device 3 wake up and sleep at a same pace.

T_{delay} may be sent by the gateway device to the electronic device 3 in a process of adding the electronic device 3, or may be sent by the gateway device to the electronic device 3 through the first synchronization instruction, or may be preset in the electronic device 3. This is not limited in this embodiment.

Manner 2: The gateway device may send the first synchronization instruction to the electronic device 3 at a first moment after the electronic device 1 and the electronic device 2 start a new T_{A-old}, where the first moment is within a wake-up time of T_{A-old}, a time difference between the first moment and a start moment of the wake-up time is Tₓ, Tₓ is a preset value, and Tₓ≥0. Based on this, after receiving the first synchronization instruction, the electronic device 3 performs signal scanning based on a target scanning period T_{A-new}, and shortens a wake-up time in a first target scanning period T_{A-new} by T_{delay}+Tₓ.

For example, with reference to FIG. 11C, when Tₓ=0, the gateway device may send the first synchronization instruction when the single-live-wire device 1 and the single-live-wire device 2 just start a new T_{A-old}. After receiving the first synchronization instruction, the single-live-wire device 3 shortens a wake-up time in a first signal scanning period by T_{delay}.

It may be understood that, the method provided in manner 2 is affected by T_{delay}, although the first T_{A-new} of the single-live-wire device 3 does not enter the wake-up state simultaneously with the single-live-wire device 1 and the single-live-wire device 2, the single-live-wire device 1, the single-live-wire device 2, and the single-live-wire device 3 end the wake-up state simultaneously, and enter a subsequent signal scanning period simultaneously.

It should be noted that, in this implementation, it is unnecessary to pay attention to whether an absolute time point of the gateway device is the same as an absolute time point of the single-live-wire device, and a difference between the absolute time point of the gateway device and the absolute time point of the single-live-wire device almost does not affect simultaneous wake-up and sleep of the gateway device and the single-live-wire device.

In some other implementations, the gateway device may first perform clock synchronization with the single-live-wire device 3, so that the absolute time point of the gateway device is basically the same as the absolute time point of the single-live-wire device. Based on this, the gateway device may send, to the single-live-wire device 3, a first synchronization instruction that carries a start moment K, to indicate the single-live-wire device to periodically wake up and sleep based on T_{A} from a moment K. For example, the moment K may be 09:06:30:500 on Sep. 19, 2022.

### (2) T_{A-old} and T_{A-new} are Different

When T_{A-old} and T_{A-new} are different, the gateway device needs to send the first synchronization instruction to each added single-live-wire device, to control these single-live-wire devices to perform signal scanning based on T_{A-new} synchronously.

In some implementations, the gateway device broadcasts the first synchronization instruction when the single-live-wire device 1 and the single-live-wire device 2 are in a wake-up period, and the single-live-wire device is in a continuous wake-up state, where the first synchronization instruction carries T_{A-new}. Because the single-live-wire device 1, the single-live-wire device 2, and the single-live-wire device 3 are all in the wake-up state, the single-live-wire device 1, the single-live-wire device 2, and the single-live-wire device 3 usually receive the synchronization instruction simultaneously, and perform signal scanning based on T_{A-new} simultaneously, to implement synchronization of signal scanning processes.

In some other implementations, to simplify a synchronization process of signal scanning processes of a plurality of single-live-wire devices and implement precise synchronization, the gateway device may send a wake-up instruction to all added single-live-wire devices after determining T_{A-new}, where the wake-up instruction indicates the single-live-wire devices to stay in a wake-up state for a preset time (for example, within 1 minute), and receive a wake-up response message sent by each single-live-wire device, where the wake-up response message indicates that the single-live-wire devices have entered a continuous wake-up state. After all the added single-live-wire devices enter the continuous wake-up state, the gateway device sends the first synchronization instruction to all the added single-live-wire devices, where the first synchronization instruction carries T_{A-new}. It should be understood that, because all the single-live-wire devices are in the wake-up state, all the single-live-wire devices can receive the first synchronization instruction simultaneously, and can enter the wake-up state and the sleep state based on T_{A-new} simultaneously, to implement synchronization of signal scanning processes.

In another possible implementation of S1004, to simplify a synchronization process of signal scanning processes of a plurality of single-live-wire devices and implement precise synchronization, regardless of whether T_{A-old} and T_{A-new} are the same, the gateway device may send a wake-up instruction to all added single-live-wire devices after determining T_{A-new}, where the wake-up instruction indicates the single-live-wire devices to stay in a wake-up state for a preset time (for example, 10 seconds). The single-live-wire device wakes up in response to the wake-up instruction, and sends a wake-up response message to the gateway device, where the wake-up response message indicates that the single-live-wire device has entered a continuous wake-up state. After the gateway device determines that all the added single-live-wire devices enter the continuous wake-up state, the gateway device sends the first synchronization instruction to all the devices when all the devices wake up. It should be understood that, because all the added single-live-wire devices are in the wake-up state, all the added single-live-wire devices can receive the synchronization instruction simultaneously, and can enter the wake-up state and the sleep state based on T_{A-new} simultaneously, to implement synchronization of signal scanning processes.

Optionally, in S1004, after receiving the first synchronization instruction, the single-live-wire device may return a response message (ACK) to the gateway device, or may not return a response message to the gateway device. This is not limited in this embodiment.

It should be noted that, based on S1001 to S1004, the gateway device may complete addition of the single-live-wire device, and control a signal scanning process of a newly added single-live-wire device to keep synchronous with a signal scanning process of a previously added single-live-wire device. However, each single-live-wire device has a clock of the single-live-wire device, and these clocks are usually different. Based on this, after a long time, signal scanning paces of the single-live-wire devices are different, and synchronization between wake-up and sleep in a signal scanning process is reduced. Therefore, the gateway device needs to synchronize signal scanning periods of all single-live-wire devices again at an interval of a preset time based on S1005.

S1005: The gateway device broadcasts a second synchronization instruction at an interval of a preset time, where the second synchronization instruction indicates all the single-live-wire devices in the smart home network to synchronize the signal scanning periods in a unified manner.

In some implementations, the gateway device synchronizes signal scanning periods of all added single-live-wire devices after every K target scanning periods T_{A}, where K is a preset value and is a positive integer. For example, K=100, and T_{A} is 60 ms/120 ms. After adding the single-live-wire device, the gateway device synchronizes signal scanning periods of all single-live-wire devices again at an interval of K×T_{A}=100×(60 ms +120 ms)=18 s. For example, the gateway device may send, within a wake-up time in a (K+1)^{th} signal scanning period T_{A}, the second synchronization instruction to all the added single-live-wire devices, where the second synchronization instruction indicates the single-live-wire devices to perform signal scanning again in a current target scanning period.

In some other implementations, the gateway device may send a wake-up instruction to all the added single-live-wire devices after K×T_{A}, where the wake-up instruction indicates the single-live-wire devices to stay in a wake-up state for a preset time (for example, within 30 s). The single-live-wire device wakes up in response to the wake-up instruction, and sends a wake-up response message to the gateway device, where the wake-up response message indicates that the single-live-wire device has entered a continuous wake-up state. After the gateway device determines that all the added single-live-wire devices enter the continuous wake-up state, the gateway device sends the second synchronization instruction to all the devices when all the devices wake up. It should be understood that, because all the added single-live-wire devices are in the wake-up state, all the added single-live-wire devices can receive the second synchronization instruction simultaneously, and can enter the wake-up state and the sleep state again simultaneously in the current target scanning period, to implement synchronization of signal scanning processes.

In S1005, after receiving the second synchronization instruction sent by the gateway device, the single-live-wire devices need to return response messages to the gateway device, to notify the gateway device that the single-live-wire devices have received the second synchronization instruction and have completed synchronization of the signal scanning processes. The gateway device may determine, based on the response message returned by each single-live-wire device, a synchronization state of the signal scanning periods of the single-live-wire devices in the smart home network. For example, after broadcasting the second synchronization instruction, if the gateway device receives the response messages returned by all the single-live-wire devices in the smart home network, it indicates that all the single-live-wire devices in the smart home network complete synchronization of the signal scanning processes. If a response message of the single-live-wire device 1 is not received, it is considered that the single-live-wire device 1 does not complete synchronization of the signal scanning processes, and the gateway device needs to re-execute the synchronization process in S1005, or separately send the second synchronization instruction to the single-live-wire device 1, to ensure that signal scanning periods of all single-live-wire devices in the smart home network are synchronized.

According to the method provided in this embodiment of this disclosure, the gateway device may control all the single-live-wire devices added to the gateway device to perform long-term signal scanning synchronously, so that all the single-live-wire devices can synchronously receive the control instruction of the gateway device.

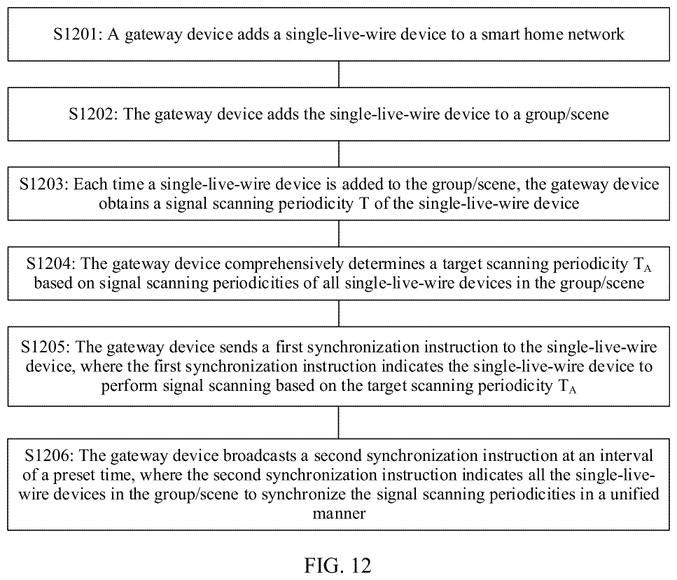

FIG. 12 is a schematic flowchart of a device control method according to an embodiment of this disclosure, and relates to a process in which a gateway device synchronizes signal scanning periods of all single-live-wire devices in a group/scene of a smart home network each time a single-live-wire device is added to the group/scene. The process specifically includes the following steps S1201 to S1206.

S1201: The gateway device adds a single-live-wire device to the smart home network. For details, refer to S1001. Details are not described herein again.

S1202: The gateway device adds the single-live-wire device to a group/scene.

Each group has a group address, and different groups have different group addresses. After adding a single-live-wire device to a group, the gateway device needs to add the single-live-wire device to a group address corresponding to the group. When sending a control instruction to each single-live-wire device in the group, the gateway device sends the control instruction to the group address.

Each scene has a scene identifier (ID), and different scenes have different scene ID addresses. After adding a single-live-wire device to a scene, the gateway device needs to send a scene identifier of the scene to the single-live-wire device. When the gateway device sends a control instruction to each single-live-wire device in the scene, the control instruction needs to carry the scene identifier. After receiving the control instruction, the single-live-wire device detects whether the scene identifier carried in the control instruction is the same as a locally stored scene identifier. If the scene identifier carried in the control instruction is the same as the locally stored scene identifier, the single-live-wire device executes an indication of the control instruction; or if the scene identifier carried in the control instruction is different from the locally stored scene identifier, the single-live-wire device ignores the control instruction.

It should be noted that there are usually a plurality of single-live-wire devices in a group/scene. To facilitate control and management on each single-live-wire device, the gateway device may set a device ID for each single-live-wire device in a same group/scene, and the device ID may also be referred to as a device number. The device ID uniquely identifies the single-live-wire device in the group/scene.

In some implementations, the gateway device may set a device ID of an i^{th} added single-live-wire device in the group/scene to i at an initial stage (which may be understood as before the gateway device starts deleting the single-live-wire device from the group/scene) of adding the single-live-wire device to the group/scene. For example, a device ID of a first added single-live-wire device is set to 1, and a device ID of a tenth added single-live-wire device to 10. In addition, if the gateway device deletes a single-live-wire device whose device ID is j from the group/scene, occupation of the device ID by the single-live-wire device is canceled. In a subsequent process, if the gateway device adds another single-live-wire device to the group/scene, the gateway device may allocate the device ID=j to the newly added single-live-wire device.

It should be noted that, when a same single-live-wire device is in different groups/scenes, device IDs corresponding to the same single-live-wire device are not associated with each other, and may be the same or may be different. Table 1 is used as an example. Device IDs of a single-live-wire device A in a group 1, a group 2, a scene 1, and a scene 2 are respectively a device ID 1 to a device ID 4. The device ID 1 to the device ID 4 may be the same or may be different.

TABLE 1

| Group/Scene | Group address/Scene ID | Device ID |
|---|---|---|
| Group 1 | Group 1 | Device ID 1 |
| Group 2 | Group 2 | Device ID 2 |
| Scene 1 | Scene ID 1 | Device ID 3 |
| Scene 2 | Scene ID 2 | Device ID 4 |

In addition, the gateway device may further maintain a piece of bitmap information for each scene/group. The bitmap information includes N bits, a quantity of N is greater than or equal to a total quantity of currently added single-live-wire devices in the group, and the bitmap information indicates status information of each single-live-wire device in the group/scene based on a bitmap ID. The status information of the single-live-wire device includes a join state and an exit state, where the join state indicates that the single-live-wire device is in the group, and the exit state indicates that the single-live-wire device has been added to the group but is currently deleted from the group. A specific value of the bitmap ID is 0 or 1. If the bitmap ID is 1, it indicates that the corresponding single-live-wire device is in the join state. If the bitmap ID is 0, the single-live-wire device is in the exit state.

In some implementations, a bitmap ID of a single-live-wire device whose device ID is i is in an i^{th} bit of the bitmap information. For example, a bitmap ID of a single-live-wire device whose device ID is 1 is in a first bit of the bitmap information. A bitmap ID of a single-live-wire device whose device ID is 4 is in a fourth bit of the bitmap information.

For example, bitmap information of a group A is 0b 1111 1111. In other words, the bitmap information includes eight bits, and a value of each bit is 1. In this case, the bitmap information indicates that eight single-live-wire devices are added to the group A in total, and each single-live-wire device is currently in the join state. In other words, in the group, all single-live-wire devices whose device IDs are 1 to 8 are currently in the join state.

In another example, bitmap information of a scene B is 0b 1000 0000 0000 0000 1111. In other words, the bitmap information includes 20 bits. A value of a first bit is 1, values of a second bit to a fifteenth bit are all 0, and values of a sixteenth bit to a twentieth bit are all 1. In this case, the bitmap information indicates that a single-live-wire device whose device ID is 1 in the scene B is currently in the join state, single-live-wire devices whose device IDs are 2 to 15 are currently in the exit state, and single-live-wire devices whose device IDs are 16 to 20 are in the join state.

It should be noted that, in a process in which the gateway device adds a single-live-wire device to the group/scene, if a quantity N of bits in the bitmap information is less than a quantity of added devices, the gateway device extends a length of the bitmap information, for example, from 16 bits to 32 bits (in other words, from 2 bytes to 4 bytes).

Based on the foregoing descriptions, after successfully adding the single-live-wire device to the group, the gateway device may send the group address and the device ID of the single-live-wire device to the single-live-wire device through the following instruction.

| | | |
|---|---|---|
| Attribute type | Group address | Device ID |
| | 2 bytes | 1 byte |

After successfully adding the single-live-wire device to the scene, the gateway device may send the scene identifier and the device ID corresponding to the device identifier of the single-live-wire device to the single-live-wire device through the following control instruction.

| | | |
|---|---|---|
| Attribute type | Scene ID | Device ID |
| | 2 bytes | 1 byte |

In response to the control instruction, the single-live-wire device in the group/scene sends a response message (ACK) to the gateway device, where the response message indicates that the single-live-wire device has received the control instruction. For example, the response message may be shown as follows:

| | |
|---|---|
| Attribute type | Status |

S1203: Each time a single-live-wire device is added to the group/scene, the gateway device obtains a signal scanning period T of the single-live-wire device.

After the gateway device successfully adds the single-live-wire device to the group/scene, the single-live-wire device may report information like a device attribute and the signal scanning period T of the single-live-wire device automatically or based on an indication of the gateway device. For details about the device attribute, the signal scanning period T, and the like, refer to the foregoing descriptions. Details are not described herein again.

S1204: The gateway device comprehensively determines a target scanning period T_{A} based on signal scanning periods of all the single-live-wire devices in the group/scene. For a specific determining manner, refer to S1003. Details are not described herein again.

Optionally, the gateway device may not perform S1203 and S1204. To be specific, the gateway device does not comprehensively determine the target scanning period T_{A} based on the signal scanning periods of all the single-live-wire devices added to the group/scene, but determines a preset signal scanning period as the target scanning period T_{A}. The preset signal scanning period is generally universal, that is, is applicable to most single-live-wire devices. For example, the preset signal scanning period is “60 ms/160 ms”.

S1205: The gateway device sends a first synchronization instruction to the single-live-wire device, where the first synchronization instruction indicates the single-live-wire device to perform signal scanning based on the target scanning period T_{A}. For a specific sending manner, refer to S1004. Details are not described herein again.

S1206: The gateway device broadcasts a second synchronization instruction at an interval of a preset time, where the second synchronization instruction indicates all single-live-wire devices that have been added to the group/scene to synchronize the signal scanning periods in a unified manner.

According to the method provided in this embodiment of this disclosure, the gateway device may control all the single-live-wire devices in each group/scene of the gateway device to perform long-term signal scanning synchronously, so that all the single-live-wire devices can synchronously receive the control instruction of the gateway device.

After successfully adding a smart home device, the gateway device needs to perform heartbeat monitoring on each smart home device, that is, detect whether each smart home device is online. If it is detected that a smart home device is offline, the smart home device is ignored in a process of synchronizing signal scanning periods. If it is detected that a smart home device goes online again after going offline, a signal scanning period needs to be synchronized for the smart home device again. For a specific synchronization process, refer to S1002 to S1004 or S1203 to S1205. Details are not described in this embodiment.

### (2) Device Control Process

After the single-live-wire devices in the smart home network complete signal scanning synchronization, the gateway device can simultaneously control the plurality of single-live-wire devices by the groups/scenes.

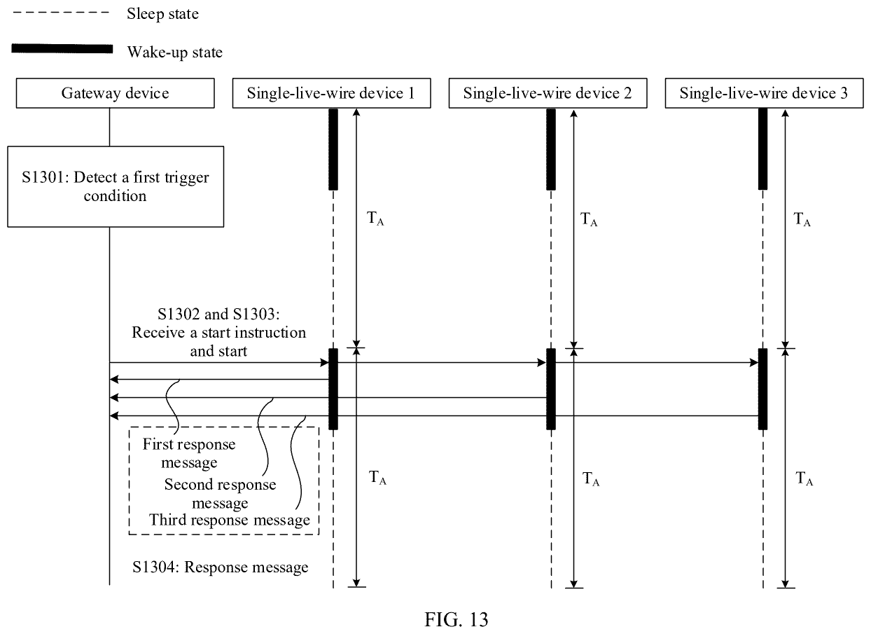

FIG. 13 is a schematic flowchart of a device control method according to an embodiment of this disclosure, and relates to a process in which a gateway device simultaneously controls a plurality of single-live-wire devices. The process specifically includes the following steps S1301 to S1304.

S1301: The gateway device detects a first trigger condition, where the first trigger condition indicates to control all single-live-wire devices in a target group/scene to be turned on.

In this embodiment, the first trigger condition may be a voice control instruction of a user, for example, “Hey Celia, turn on all lights at home”. Alternatively, the first trigger condition may be that a preset time point is reached, for example, an early start alarm time point is reached. Alternatively, the first trigger condition may be that the user performs an operation on the gateway device or a control device to start the target group/scene, for example, taps a start control of a “going home” scene in an AI LIFE application of a mobile phone. In conclusion, the first trigger condition is not specifically limited in this embodiment.

S1302: The gateway device sends a start instruction to the single-live-wire device in the target group/scene in response to the first trigger condition.

It can be learned from the foregoing descriptions that, the single-live-wire devices in the target group/scene wake up and sleep synchronously, so that signal scanning is performed intermittently. The gateway device knows a target scanning period T_{A} of the target group/scene and a start moment in each target scanning period T_{A}. Based on this, the gateway device may send the start instruction to all the single-live-wire devices in the target group/scene in a common wake-up period of the single-live-wire devices in the target group/scene.

If a control object is the target group, the start instruction needs to carry a group address of the target group. If a control object is the target scene, the start instruction needs to carry a scene identifier.

The gateway device may send the start instruction to the single-live-wire device in the target group/scene a plurality of times in the wake-up period, to improve a rate of successfully receiving the start instruction by the single-live-wire device. For example, for a signal scanning period T_{A}=60 ms/120 ms, a wake-up period of the signal scanning period is 60 ms. The gateway device may quickly send a start instruction to the single-live-wire device in the target group/scene for three times (for example, send a start instruction at an interval of 1 ms) in first 20 ms of the wake-up period, to ensure that the single-live-wire device quickly receives the start instruction, and improve a response speed of starting the single-live-wire device. In addition, the gateway device may also send a start instruction at an interval of 20 ms in last 40 ms of the wake-up period, to ensure that a single-live-wire device that does not receive the start instruction can receive the start instruction again, thereby improving a success rate of device startup.

It should be noted that the gateway device sends the start instruction to the single-live-wire device in the target group/scene based on an instruction of an application layer. In this process, a delay exists in both delivery of the instruction of the application layer and end-to-end delivery of the start instruction. Therefore, the gateway device may immediately send the start instruction after the wake-up time of the single-live-wire device expires, to quickly start the single-live-wire device. In other words, the gateway device may not need to delay sending the start instruction after the wake-up period of the single-live-wire device starts. Similarly, the single-live-wire device does not need to enter a wake-up state in advance to wait for receiving the start instruction. Certainly, after the wake-up period of the single-live-wire device is reached, the gateway device may also delay sending the start instruction, or all single-live-wire devices in the target group/scene may enter the wake-up state by a preset time (for example, 3 ms) in advance in each wake-up period. This is not limited in this embodiment of this disclosure.

S1303: All single-live-wire devices in the target group/scene simultaneously start in response to the start instruction.

When the gateway device sends the start instruction, all the single-live-wire devices in the target group/scene are in the wake-up state simultaneously. Therefore, these single-live-wire devices usually can receive the start instruction simultaneously and start working simultaneously. It should be noted that after the single-live-wire device starts, if the single-live-wire device receives a same start instruction again, the single-live-wire device ignores the start instruction, and continues to maintain a working state after startup.

S1304: All single-live-wire devices in the target group/scene each return a response message to the gateway device, where the response message is used to notify the gateway device that the single-live-wire device has received the start instruction.

In some implementations, the single-live-wire device may return a response message to the gateway device in a time division manner based on a device ID of the single-live-wire device in the target group/scene, where the response message carries the device ID of the single-live-wire device. According to the method, the gateway device can receive the response message of each single-live-wire device in the time division manner. This reduces uplink network congestion on the gateway device.

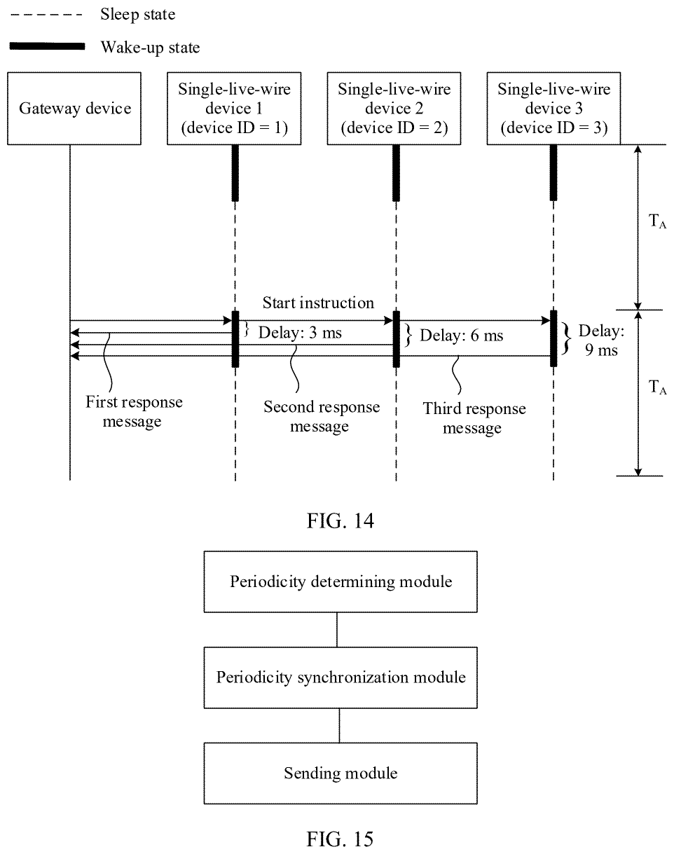

Optionally, a single-live-wire device returns a response message to the gateway device at a K^{th} second after receiving the start instruction, where K=T×device ID. For example, refer to FIG. 14. For example, if K=3 ms, for a single-live-wire device 1 whose device ID is 1, the single-live-wire device 1 needs to return a first response message to the gateway device at a 3^{rd} ms after receiving the start instruction; for a single-live-wire device 2 whose device ID is 2, the single-live-wire device 2 needs to return a second response message to the gateway device at a 6^{th} ms after receiving the start instruction; and for a single-live-wire device 3 whose device ID is 3, the single-live-wire device 3 needs to return a third response message to the gateway device at a 9^{th} ms after receiving the start instruction. Because device IDs of all single-live-wire devices in the target group/scene are different, the single-live-wire devices return response messages to the gateway device at different time points, so that the response messages are returned in the time division manner.

Because the response message sent by each single-live-wire device carries the device ID of the single-live-wire device, the gateway device may determine a start status of each single-live-wire device in the target group/scene based on the received response message. In other words, if the gateway device receives the response message carrying the device ID=1, it is determined that the single-live-wire device 1 starts; and if the gateway device does not receive the response message carrying the device ID=3, it is determined that the single-live-wire device 3 does not start. For a single-live-wire device that does not start within the preset time, the gateway device may send the start instruction to the single-live-wire device again.

It should be noted that S1304 is an optional step. In other words, after each single-live-wire device in the target group/scene starts, the single-live-wire device may not send a response message to the gateway device.

In conclusion, according to the method provided in this embodiment, the gateway device can control a plurality of electronic devices in one group/scene to start working simultaneously, and this helps improve user experience. For example, the gateway device can control a plurality of single-live-wire lights in a smart home network to be turned on simultaneously, to avoid a case in which the lights are turned on successively, thereby improving user experience.

It should be understood that sequence numbers of the steps do not mean execution sequences in the foregoing embodiments. The execution sequences of the processes should be determined based on functions and internal logic of the processes, and should not be construed as any limitation on the implementation processes of embodiments of this disclosure.

FIG. 15 shows a device control apparatus according to an embodiment of this disclosure. The apparatus is used in a gateway device, and includes a period determining module, a period synchronization module, and a sending module. The period determining module is configured to determine a target scanning period of the plurality of electronic devices, where the target scanning period includes a wake-up time and a sleep time; and the electronic device performs signal scanning when the electronic device is within the wake-up time, and does not perform signal scanning when the electronic device is within the sleep time. The period synchronization module is configured to synchronize signal scanning processes of the plurality of electronic devices based on the target scanning period. The sending module is configured to send a control instruction to the plurality of electronic devices simultaneously when the plurality of electronic devices are all within the wake-up time in the target scanning period.

In some implementations, that the period determining module is configured to determine the target scanning period of the plurality of electronic devices specifically includes: obtaining a plurality of signal scanning periods respectively corresponding to the plurality of electronic devices; determining a plurality of duty cycles respectively corresponding to the plurality of signal scanning periods, where the duty cycle is a ratio of a wake-up time to a sleep time in the signal scanning period; determining a smallest duty cycle in the plurality of duty cycles; and determining N times a signal scanning period corresponding to the smallest duty cycle as the target scanning period, where N>0.

In some implementations, that the period determining module is configured to determine the target scanning period of the plurality of electronic devices specifically includes: determining a preset signal scanning period as the target scanning period of the plurality of electronic devices.

In some implementations, the plurality of electronic devices includes at least one first electronic device and a second electronic device. Before determining the target scanning period of the plurality of electronic devices, the method further includes: connecting to the second electronic device in a process in which the at least one first electronic device performs signal scanning synchronously based on a historical scanning period, where after the second electronic device is connected and before the signal scanning processes of the plurality of electronic devices are synchronized, the second electronic device is continuously in a wake-up state within a preset time.

In some implementations, that the period synchronization module is configured to synchronize the signal scanning processes of the plurality of electronic devices based on the target scanning period specifically includes: sending a first synchronization instruction to the plurality of electronic devices simultaneously when the plurality of electronic devices are all in the wake-up state, where the first synchronization instruction indicates the electronic device to perform signal scanning based on the target scanning period.

In some implementations, that the period synchronization module is configured to synchronize the signal scanning processes of the plurality of electronic devices based on the target scanning period specifically includes: sending a first synchronization instruction to the second electronic device at a first moment in the historical scanning period if the historical scanning period is the same as the target scanning period, where the first synchronization instruction indicates the electronic device to perform signal scanning based on the target scanning period. The first moment is before a start moment of a wake-up time in the historical scanning period, a time difference between the first moment and the start moment of the wake-up time is T₁, and T₁ is a delay of the first synchronization instruction from the gateway device to the second electronic device. Alternatively, the first moment is within a wake-up time in the historical scanning period, a time difference between the first moment and a start moment of the wake-up time is T₂, and T₂ is a preset value.

In some implementations, that the period synchronization module is configured to synchronize the signal scanning processes of the plurality of electronic devices based on the target scanning period further includes: sending a second synchronization instruction to the plurality of electronic devices simultaneously at an interval of a preset time after the first synchronization instruction is sent, where the second synchronization instruction indicates the electronic device to restart signal scanning based on the target scanning period.

In some implementations, the period synchronization module is further configured to: if the plurality of electronic devices are in a same device set, create bitmap information of the device set, where the bitmap information includes a plurality of bits, and an i^{th} bit indicates status information of an electronic device whose device ID is i; after each electronic device is added to the device set, allocate a device ID to the electronic device; and register, at a bit corresponding to the device ID, the status information of the electronic device corresponding to the device ID.

In some implementations, a receiving module is further configured to sequentially receive, in ascending order of device IDs, response messages returned by the plurality of electronic devices.

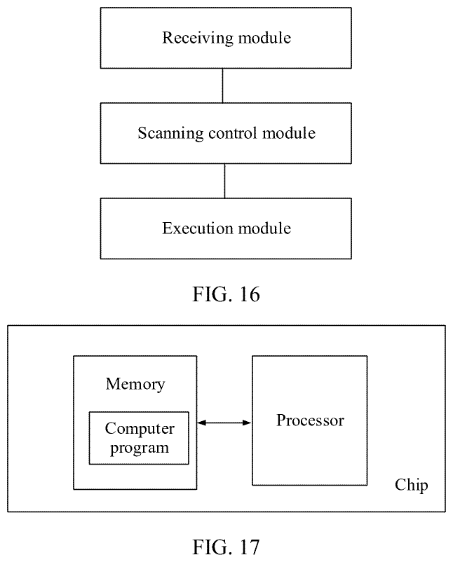

FIG. 16 shows a device control apparatus according to another embodiment of this disclosure. The apparatus is used in an electronic device, and specifically includes the following modules: a receiving module, configured to receive a first synchronization instruction, where the first synchronization instruction carries a target scanning period, and the target scanning period is determined based on signal scanning periods of a plurality of electronic devices in a control network in which the electronic device is located; a scanning control module, configured to perform signal scanning based on the target scanning period; and an execution module, configured to execute a received control instruction.

In some implementations, that the scanning control module is configured to perform signal scanning based on the target scanning period specifically includes: after the first synchronization instruction is received, performing signal scanning based on the target scanning period, and shortening a wake-up time in a first target scanning period by T₁+T₂, where T₁ is a delay of the first synchronization instruction from a gateway device to the electronic device, and T₂ is a value notified by the gateway device or a preset value.

In some implementations, the receiving module is further configured to receive a second synchronization instruction, where the second synchronization instruction carries the target scanning period; and the scanning control module is further configured to restart signal scanning based on the target scanning period in response to the second synchronization instruction.

In some implementations, the apparatus further includes a sending module, where the sending module is configured to: after the instruction sent by the gateway device is received, send a response message to the gateway device at a K^{th} second, where K=T×device ID, and T is a preset value.

An embodiment of this disclosure further provides a chip. Refer to FIG. 17. The chip includes a processor and a memory. The memory stores a computer program. When the computer program is executed by the processor, the method performed by the gateway device or the electronic device in the foregoing embodiments is implemented.

An embodiment of this disclosure further provides a computer-readable storage medium. The computer-readable storage medium stores a computer program. When the computer program is executed by a processor, the method performed by the gateway device or the electronic device provided in the foregoing embodiments is implemented.

An embodiment of this disclosure further provides a computer program product. The program product includes a computer program. When the computer program is run by an electronic device, the electronic device is enabled to implement the method performed by the gateway device or the electronic device provided in the foregoing embodiments.

It should be understood that the processor in embodiments of this disclosure may be a central processing unit (CPU), or may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any processor or the like.

It may be understood that the memory mentioned in embodiments of this disclosure may be a volatile memory or a non-volatile memory, or may include a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random-access memory (RAM), used as an external cache. Through example but not limitative description, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), and a direct Rambus RAM (DR RAM).

In embodiments provided in this disclosure, division into the frameworks or modules is merely logical function division and may be other division in actual implementation. For example, a plurality of frameworks or modules may be combined or integrated into another system, or some features may be ignored or not performed.

In addition, function modules in this disclosure may be integrated into one processing module, or each of the modules may exist alone physically, or two or more modules are integrated into one module. The integrated module may be implemented in a form of hardware, or may be implemented in a form of a software function module.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

Reference to “an embodiment”, “some embodiments”, or the like described in this specification indicates that one or more embodiments of this disclosure include a specific feature, structure, or characteristic described with reference to the embodiments. Therefore, statements such as “in an embodiment”, “in some embodiments”, “in some other embodiments”, and “in other embodiments” that appear at different places in this specification do not necessarily mean reference to a same embodiment, instead, they mean “one or more but not all of embodiments”, unless otherwise specifically emphasized. The terms “include”, “comprise”, “have”, and their variants all mean “include but are not limited to”, unless otherwise specifically emphasized.

The foregoing embodiments are merely intended to describe the technical solutions of this disclosure, but are not to limit this disclosure. Although this disclosure is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of embodiments of this disclosure, and these modifications and replacements shall fall within the protection scope of this disclosure.

1. A system, comprising:
a plurality of electronic devices; and
a gateway device connected to the plurality of electronic devices, wherein the gateway device is configured to:
determine a target scanning period of the plurality of electronic devices, wherein the target scanning period comprises a wake-up time and a sleep time;
synchronize signal scanning processes of the plurality of electronic devices based on the target scanning period by sending a first synchronization instruction to the plurality of electronic devices simultaneously when the plurality of electronic devices is in a wake-up state, wherein the first synchronization instruction instructs the plurality of electronic devices to perform signal scanning based on the target scanning period; and
send a control instruction to the plurality of electronic devices when the plurality of electronic devices is within the wake-up time,
wherein each of the plurality of the electronic devices is configured to receive and execute the control instruction.

2. The system of claim 1, wherein the gateway device is further configured to further determine the target scanning period by:
obtaining a plurality of signal scanning periods respectively corresponding to the plurality of electronic devices;
determining a plurality of duty cycles respectively corresponding to the plurality of signal scanning periods, wherein a duty cycle is a ratio of a wake-up time to a sleep time in the signal scanning period;
determining a smallest duty cycle in the plurality of duty cycles; and
determining N times a signal scanning period corresponding to the smallest duty cycle as the target scanning period, wherein N>0.

3. The system of claim 1, wherein the gateway device is further configured to further determine the target scanning period by determining a preset signal scanning period as the target scanning period of the plurality of electronic devices.

4. The system of claim 1, wherein the plurality of electronic devices comprises:
at least one first electronic device; and
a second electronic device,
wherein the at least one first electronic device is configured to perform, when the gateway device is connected to the at least one first electronic device but is not connected to the second electronic device, signal scanning synchronously based on a historical scanning period, and
wherein after the gateway device is connected to the second electronic device, and before the gateway device synchronizes the signal scanning processes, the second electronic device is continuously in a wake-up state within a preset time.

5. The system of claim 4, wherein the gateway device is further configured to further synchronize the signal scanning processes by sending, when the historical scanning period is the same as the target scanning period, a first synchronization instruction to the second electronic device at a first time, wherein the first synchronization instruction instructs the second electronic device to perform signal scanning based on the target scanning period, and
wherein the second electronic device is configured to:
perform signal scanning based on the target scanning period when the first time is before a start of a wake-up time in a next historical scanning period, when a time difference between the first time and a start time of the wake-up time is T_{delay}, and after the first synchronization instruction is received, wherein T_{delay} is a delay of the first synchronization instruction from the gateway device to the second electronic device; or
perform signal scanning based on the target scanning period, and shorten a wake-up time in a first target scanning period by T_{delay}+Tₓ, when the first time is within a wake-up time in the historical scanning period, when a time difference between the first time and a start time of the wake-up time is Tₓ, and after the first synchronization instruction is received, wherein Tₓ is a preset value.

6. The system of claim 4, wherein the gateway device is further configured to send a second synchronization instruction to the plurality of electronic devices simultaneously at an interval of a preset time after sending the first synchronization instruction, wherein the second synchronization instruction instructs the plurality of electronic devices to restart signal scanning based on the target scanning period, and wherein the plurality of electronic devices is further configured to restart signal scanning based on the target scanning period in response to the second synchronization instruction.

7. The system of claim 1, wherein the gateway device is further configured to:
create, when the plurality of electronic devices is in a same device set, bitmap information of the device set, wherein the bitmap information comprises a plurality of bits, and wherein an i^{th} bit indicates status information of a first electronic device having a first device ID of i;
allocate, after each electronic device of the plurality of electronic devices is added to the device set, a device ID to each electronic device; and
register, at a bit corresponding to the device ID, status information of the electronic device corresponding to the device ID.

8. The system of claim 7, wherein the plurality of electronic devices is further configured to, after receiving an instruction sent by the gateway device, sequentially send response messages to the gateway device in ascending order of device IDs.

9. The system of claim 8, wherein each electronic device is further configured to send, after receiving the instruction from the gateway device, a response message to the gateway device at a K^{th} second, wherein K=T×device ID, and wherein Tis a preset value.

10. A method applied to a gateway device and comprising:
determining a target scanning period of a plurality of electronic devices, wherein the target scanning period comprises a wake-up time and a sleep time;
synchronizing signal scanning processes of the plurality of electronic devices based on the target scanning period by sending a first synchronization instruction to the plurality of electronic devices simultaneously when the plurality of electronic devices is in a wake-up state, wherein the first synchronization instruction instructs the plurality of electronic devices to perform signal scanning based on the target scanning period; and
sending a control instruction to the plurality of electronic devices when the plurality of electronic devices is within the wake-up time.

11. The method of claim 10, wherein determining the target scanning period comprises:
obtaining a plurality of signal scanning periods respectively corresponding to the plurality of electronic devices;
determining a plurality of duty cycles respectively corresponding to the plurality of signal scanning periods, wherein a duty cycle is a ratio of a wake-up time to a sleep time in the signal scanning period;
determining a smallest duty cycle in the plurality of duty cycles; and
determining N times a signal scanning period corresponding to the smallest duty cycle as the target scanning period, wherein N>0.

12. The method of claim 10, wherein determining a target scanning period of the plurality of electronic devices comprises determining a preset signal scanning period as the target scanning period of the plurality of electronic devices.

13. The method of claim 10, wherein the plurality of electronic devices comprises at least one first electronic device and a second electronic device, and before the determining a target scanning period of the plurality of electronic devices, wherein the method further comprises connecting to the second electronic device in a process in which the at least one first electronic device performs signal scanning synchronously based on a historical scanning period, and wherein after the second electronic device is connected and before the signal scanning processes of the plurality of electronic devices are synchronized, the second electronic device is continuously in a wake-up state within a preset time.

14. The method of claim 13, wherein synchronizing the signal scanning processes comprises sending a first synchronization instruction to the second electronic device at a first time when the historical scanning period is the same as the target scanning period, wherein the first synchronization instruction instructs the second electronic device to perform signal scanning based on the target scanning period,
wherein the first time is before a start of a wake-up time in a next historical scanning period, wherein a time difference between the first time and a start time of the wake-up time is T_{delay}, and wherein T_{delay} is a delay of the first synchronization instruction from the gateway device to the second electronic device, or
wherein the first time is within a wake-up time in the historical scanning period, wherein a time difference between the first time and a start time of the wake-up time is Tₓ, and wherein Tₓ is a preset value.

15. The method of claim 13, wherein synchronizing the signal scanning processes further comprises sending a second synchronization instruction to the plurality of electronic devices simultaneously at an interval of a preset time after sending the first synchronization instruction, wherein the second synchronization instruction instructs the plurality of electronic devices to restart signal scanning based on the target scanning period.

16. The method of claim 10, wherein when the plurality of electronic devices is in a same device set, the method further comprises:
creating bitmap information of the device set, wherein the bitmap information comprises a plurality of bits, and wherein an i^{th} bit indicates status information of a first electronic device having a first device ID of i;
allocating, after each electronic device of the plurality of electronic devices is added to the device set, a device ID to each electronic device; and
registering, at a bit corresponding to the device ID, the status information of the electronic device corresponding to the device ID.

17. The method of claim 16, wherein the method further comprises sequentially receiving, in ascending order of device IDs, response messages returned by the plurality of electronic devices.

18. A method applied to an electronic device in a control network and comprising:
receiving a first synchronization instruction, wherein the first synchronization instruction comprises a target scanning period determined based on signal scanning periods of a plurality of electronic devices in the control network;
performing signal scanning based on the target scanning period;
receiving a control instruction within a wake-up time in the target scanning period;
shortening the wake-up time in the target scanning period by T_{delay}+Tₓ, wherein T_{delay} is a delay of the first synchronization instruction from a gateway device to the electronic device, and wherein Tₓ is a value notified by the gateway device or a preset value; and
executing the control instruction.

19. The method of claim 18, further comprising:
receiving a second synchronization instruction, wherein the second synchronization instruction comprises the target scanning period; and
restarting, in response to the second synchronization instruction, the signal scanning according to the target scanning period.

20. The method of claim 18, further comprising sending, after receiving the control instruction, a response message at a K^{th} second, where K=T×device ID, and T is a preset value.
